(19) United States
(12) Patent Application Publication
(10) Pub. No.: US 2024/0114390 A1
(43) Pub. Date: Apr. 4, 2024

(54) STEERING MODE SELECTION

(71) Applicant: Comcast Cable Communications, LLC, Philadelphia, PA (US)

(72) Inventors: Ana Lucia Pinheiro, Allen, TX (US); Robert Jaksa, Irving, TX (US)

(21) Appl. No.: 18/479,585

(22) Filed: Oct. 2, 2023

Related U.S. Application Data
(60) Provisional application No. 63/411,982, filed on Sep. 30, 2022.

(51) Int. Cl. H04W 28/08; H04W 64/00

(52) U.S. Cl. CPC H04W 28/0925; H04W 64/006

(57) ABSTRACT

A method includes sending a request to connect a user device to a first network or a second network. The method includes receiving a policy. The policy includes a first rule indicative of a first mode and the first rule is associated with a parameter based on a geolocation of the user device. The first mode is indicative of access to one or more of the first network or the second network. The method includes determining a first subflow of a connection according to a first path. The method also includes determining a second subflow of the connection according to a second path.

### BACKGROUND

Network operators provide access to networks and the Internet. Access may be provided through access points and radio access networks. For example, one network operator may provide access through radio access networks including nodes (e.g., gNB), and another operator may provide access through wireless access points. Each access medium may have intrinsic benefits and detriments, and arbitrary connections and associations to each access medium may lead to unnecessary congestion or network overhead.

### SUMMARY

Methods, apparatuses, and systems are described for improving data accessibility. For a better understanding of the underlying concepts, there follows specific non-limiting examples:

Network operators may provide data network access to user devices (e.g., user equipment). For instance, network operators may provide access to a data network though different technologies and one or more of the network operators may include a transport converter (e.g., proxy). The transport converter may allow the user device to communicate over both networks to a server (e.g., an application server) on one of the networks or the data network. For example, an application server may be accessible over the Internet through one or more of the network operators. The transport converter may convert multipath communications from the user device to single path communications for application server. For example, the application server may be configured to only support one session with the user device.

As disclosed herein, a policy may be used to control traffic over the networks. For example, quality of service (QOS) or other initiatives may be carried out or required by the policy. Policies may be stored in a policy controller (e.g., a policy control function). The policy or policies may include filters or steering rules, and policies may contain lists of rules. For example, the rules may be related to steering of data between the user device and the data network. A rule may be associated with a parameter based on a geolocation of the user device. For example, global positioning system (GPS) coordinates may be used to locate the user device. The rule may be configured to control data on the multipath connection based on the parameter.

For example, the rule may control data on the multipath connection based on a boundary and the parameter. The boundary may be indicative of an area that the specific rule is applicable. For example, an overflow rule may allow data to traverse a cellular network once a Wi-Fi network uses a specific percentage of the paths available data rate when the user device is within the boundary. The user device may have access to additional throughput, and the steering rules may enable the user device to access the additional throughput based on the boundary. The boundary may also enable or disable (c.g., active-standby) paths based on the boundary.

The boundary may be various geometric shapes or sizes. For example, the boundary may be a circle or an oval. The boundary may be a ring or have an inner or outer edge. The boundary may be drawn by a user of the user device on the user device. For example, an image of a map may be presented to the user for the user to establish areas that the policy is application. The interface may provide drawing tools, such as a free-form drawing tool or predefined shape tool. The boundary may be associated with a subscription or subscription package. For example, the boundary may be associated with one or more subscriber identity module (SIM). The subscription package may permit a quantity of boundaries. These and other technical improvements are discussed herein.

### BRIEF DESCRIPTION OF THE DRAWINGS

In order to provide understanding techniques described, the figures provide non-limiting examples in accordance with one or more implementations of the present disclosure, in which:

FIG. 1A illustrates an example system in accordance with one or more implementations of the present disclosure.

FIG. 1B illustrates an example system diagram in accordance with one or more implementations of the present disclosure.

FIG. 1C illustrates an example system diagram in accordance with one or more implementations of the present disclosure.

FIG. 1D illustrates an example system diagram in accordance with one or more implementations of the present disclosure.

FIG. 1E illustrates an example system diagram in accordance with one or more implementations of the present disclosure.

FIG. 2 illustrates an example communication architecture in accordance with one or more implementations of the present disclosure.

FIG. 3 illustrates an example communication architecture in accordance with one or more implementations of the present disclosure.

FIG. 4 illustrates an example communication architecture in accordance with one or more implementations of the present disclosure.

FIG. 5 illustrates an example protocol stack in accordance with one or more implementations of the present disclosure.

FIG. 6 illustrates an example communication link in accordance with one or more implementations of the present disclosure.

FIG. 7 illustrates an example control framework in accordance with one or more implementations of the present disclosure.

FIG. 8A illustrates an example policy in accordance with one or more implementations of the present disclosure.

FIG. 8B illustrates an example policy in accordance with one or more implementations of the present disclosure.

FIG. 9 illustrates an example encoding in accordance with one or more implementations of the present disclosure.

FIG. 10 illustrates an example map in accordance with one or more implementations of the present disclosure.

FIG. 11 illustrates an example mode in accordance with one or more implementations of the present disclosure.

FIG. 12 illustrates an example mode in accordance with one or more implementations of the present disclosure.

FIG. 13 illustrates example illustration associated with enabling a mode in accordance with one or more implementations of the present disclosure.

FIG. 14 illustrates an example interface in accordance with one or more implementations of the present disclosure.

FIG. 15 illustrates an example method in accordance with one or more implementations of the present disclosure.

FIG. 16 illustrates an example method in accordance with one or more implementations of the present disclosure.

FIG. 17 illustrates an example method in accordance with one or more implementations of the present disclosure.

FIG. 18 illustrates an example method for training one or more networks in accordance with one or more implementations of the present disclosure.

FIG. 19 illustrates an example method in accordance with one or more implementations of the present disclosure.

FIG. 20 illustrates an example method in accordance with one or more implementations of the present disclosure.

FIG. 21 illustrates an example method in accordance with one or more implementations of the present disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a -readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a special purpose computer or other programmable data processing instrument to produce a machine, such that the processor-executable instructions which execute on the computer or other programmable data processing instrument create a device for implementing the steps specified in the flowchart block or blocks.

These processor-executable instructions may also be stored in a non-transitory computer-readable memory or a computer-readable medium that may direct a computer or other programmable data processing instrument to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing instrument to cause a series of operational steps to be performed on the computer or other programmable instrument to produce a computer-implemented process such that the processor-executable instructions that execute on the computer or other programmable instrument provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The method steps recited throughout this disclosure may be combined, omitted, rearranged, or otherwise reorganized with any of the figures presented herein and are not intend to be limited to the four corners of each sheet presented.

The techniques disclosed herein may be implemented on a computing device in a way that improves the efficiency of its operation. As an example, the methods, instructions, and steps disclosed herein may improve the functioning of a computing device.

A multipath connection may be formed to connect one or more endpoints with the freedom to transmit data over different paths. Some endpoints may lack support for multipath communications, and a transport converter may provide backwards compatibility for endpoints that do not support multipath communications. The transport converter may provide multipath availability to those endpoints or portions of the connections that support multipath connections.

With these freedoms, a policy may be used to control endpoint and node multipath capabilities. As disclosed herein, a policy may be used to control traffic over the networks. For example, quality of service (QOS) or other initiatives may be carried out or required by the policy. Policies may be stored in a policy controller (e.g., a policy control function). The policy or policies may include filters or steering rules, and policies may contain lists of rules. For example, the rules may be related to steering of data between the user device and the data network. A rule may be associated with a parameter based on a geolocation of the user device. For example, global positioning system (GPS) coordinates may be used to locate the user device. The geolocation may be based on a base station or access point associated with networks 210, 240. For example, the geolocation may be triangulated based on one or more of the base stations or access points. The rule may be configured to control data on the multipath connection based on the parameter.

For example, the rule may control data on the multipath connection based on a boundary and the parameter. The boundary may be indicative of an area that the specific rule is applicable. For example, an overflow rule may allow data to traverse a cellular network once a Wi-Fi network uses a specific percentage (e.g., 95% or 100%) of the paths available data rate when the user device is within the boundary. The user device may have access to additional throughput, and the steering rules may enable the user device to access the additional throughput based on the boundary.

The boundary may be various geometric shapes or sizes. For example, the boundary may be a circle or an oval. The boundary may be a ring or have an inner or outer edge. The boundary may be drawn by a user of the user device on the user device. For example, an image of a map may be presented to the user for the user to establish which areas they would like the policy to apply. The interface may provide drawing tools, such as a free-form drawing tool or predefined shape tool. The boundary may be associated with a subscription or subscription package. For example, the boundary may be associated with one or more subscriber identity module (SIM). The subscription package may permit a quantity of boundaries. These and other technical improvements are discussed herein.

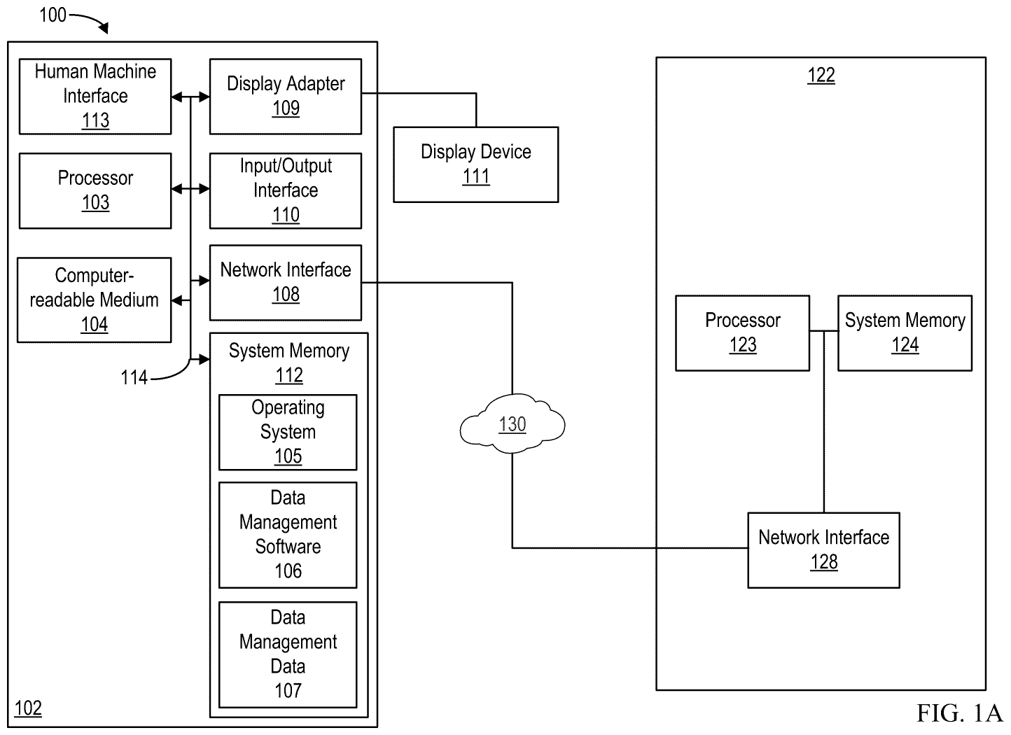

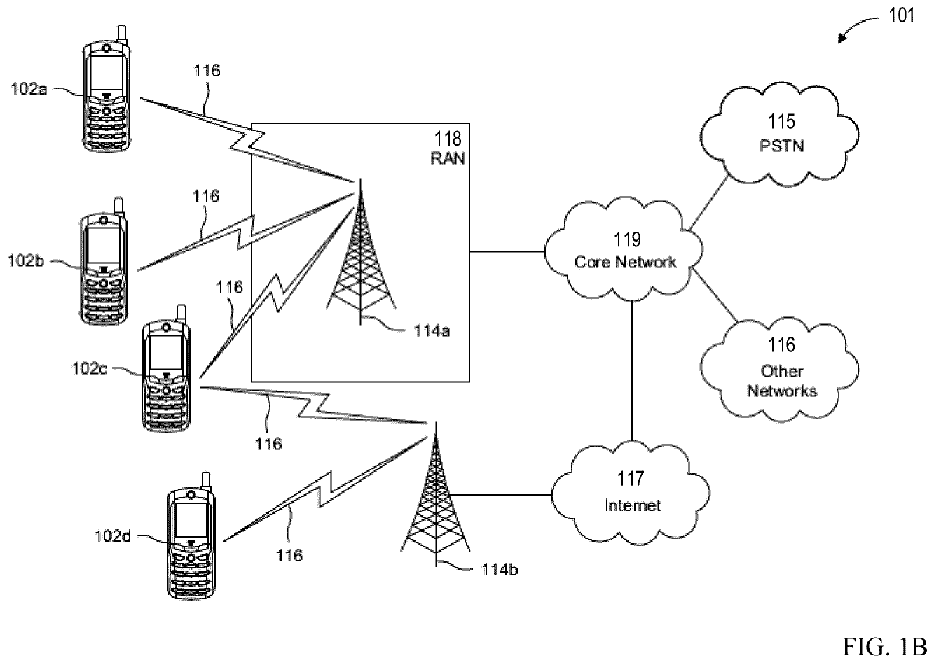

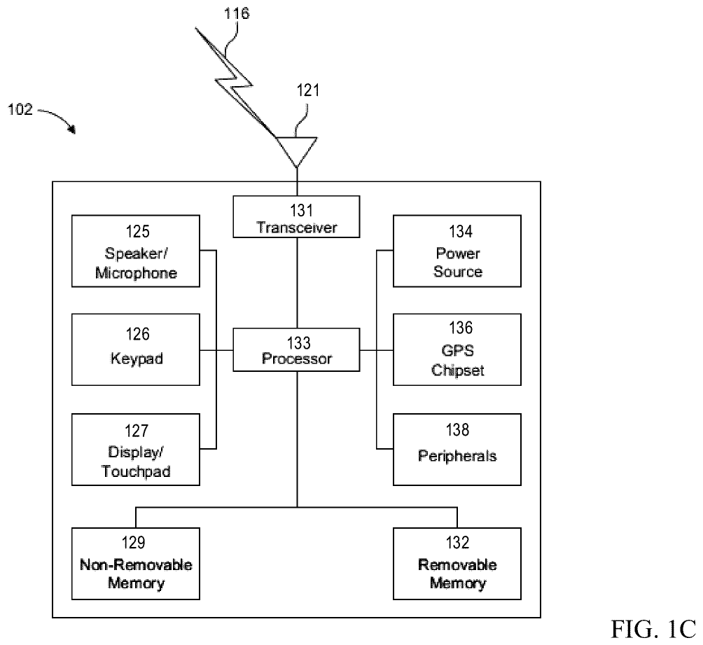

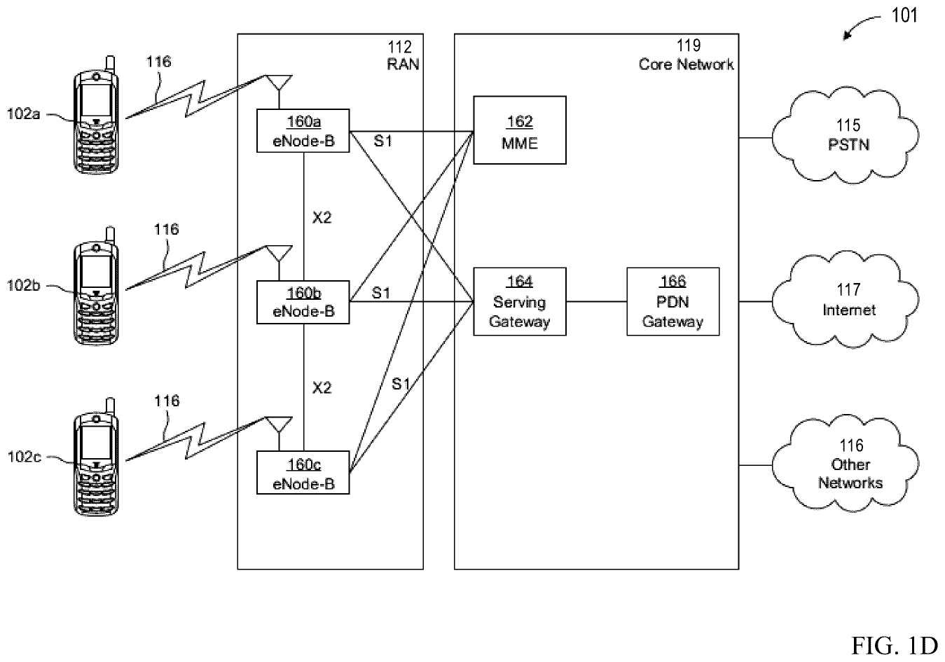

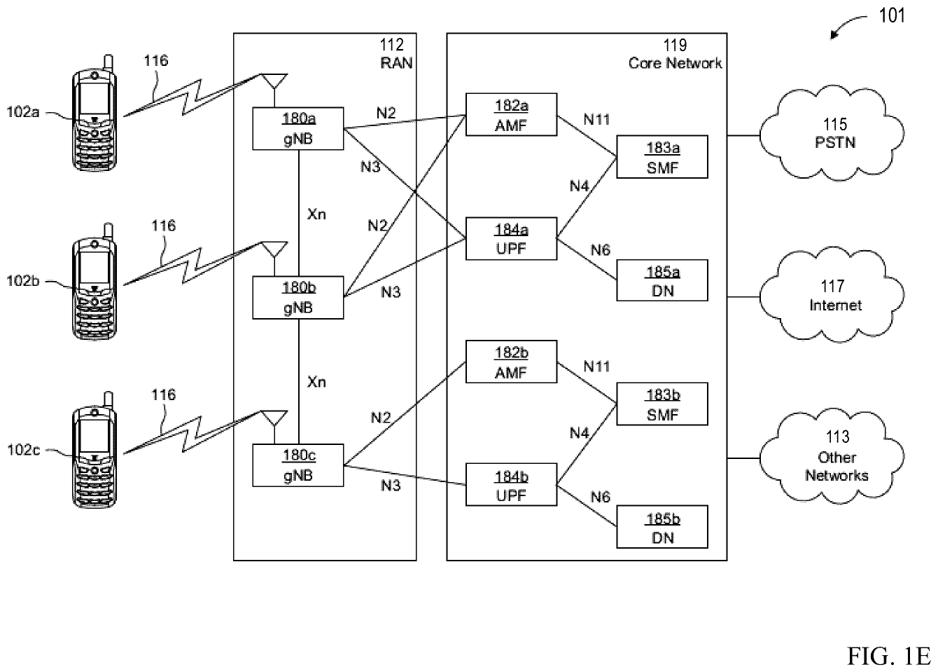

FIG. 1A shows a system 100 in accordance with one or more applications of the present disclosure. The user device 102 may comprise one or more processors 103, a system memory 112, and a bus 114 that couples various components of the user device 102 including the one or more processors 103 to the system memory 112. In the case of multiple processors 103, the user device 102 may utilize parallel computing.

The bus 114 may comprise one or more of several possible types of bus structures, such as a memory bus, memory controller, a peripheral bus, an accelerated graphics port, and a processor or local bus using any of a variety of bus architectures.

The user device 102 may operate on and/or comprise a variety of user device readable media (non-transitory). User device readable media may be any available media that is accessible by the user device 102 and comprises, non-transitory, volatile and/or non-volatile media, removable and non-removable media. The system memory 112 has user device readable media in the form of volatile memory, such as random access memory (RAM), and/or non-volatile memory, such as read only memory (ROM). The system memory 112 may store data such as data 107 and/or programs such as operating system 105 and software 106 that are accessible to and/or are operated on by the one or more processors 103.

The user device 102 may also comprise other removable/non-removable, volatile/non-volatile user device storage media. The computer-readable medium 104 may provide non-volatile storage of user device code, user device readable instructions, data structures, programs, and other data for the user device 102. The computer-readable medium 104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of programs may be stored on the computer-readable medium 104. An operating system 105 and software 106 may be stored on the computer-readable medium 104. One or more of the operating system 105 and software 106 (e.g., mobile applications), or some combination thereof, may comprise program and the software 106. Data 107 may also be stored on the computer-readable medium 104. Data 107 may be stored in any of one or more databases known in the art. The databases may be centralized or distributed across multiple locations within the network 130.

A user may enter commands and information into the user device 102 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 103 via a human machine interface 113 that is coupled to the bus 114, but may be connected by other interface and bus structures, such as a parallel port, game port, an IEEE 1394 Port (also known as a Firewire port), a serial port, network interface 108, and/or a universal serial bus (USB).

A display device 111 may also be connected to the bus 114 via an interface, such as a display adapter 109. It is contemplated that the user device 102 may have more than one display adapter 109 and the user device 102 may have more than one display device 111. A display device 111 may be a monitor, an LCD (Liquid Crystal Display), light emitting diode (LED) display, television, smart lens, smart glass, and/ or a projector. In addition to the display device 111, other output peripheral devices may comprise components such as speakers (not shown) and a printer (not shown) which may be connected to the user device 102 via Input/Output Interface 110. Any step and/or result of the methods may be output (or caused to be output) in any form to an output device. Such output may be any form of visual representation, including, but not limited to, textual, graphical, animation, audio, tactile, and the like. The display device 111 and user device 102 may be part of one device, or separate devices.

The user device 102 may operate in a networked environment using logical connections to one or more computing devices 122. A computing device 122 may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the user device 102 and a computing device 122 may be made via a network 130. Such network connections may be through a network interface 108. A network interface 108 may be implemented in both wired and wireless environments.

Application programs and other executable program components such as the operating system 105 are shown herein as discrete blocks, although it is recognized that such programs and components may reside at various times in different storage components of the user device 102, and are executed by the one or more processors 103 of the user device 102. The computing device 122 may include all of the components described with regard to the user device 102.

The user device 102 may one or more components configured to communicate over electromagnetic waves or other mediums. The user device 102 may be configured with one or more subscriber identity modules (SIM). The SIM may be stored in persistent memory, embedded, physical, or combinations thereof. In such a way, the SIM may form a credential circuit as data stored permanently or otherwise on the user device 102. The SIM may be physical or embedded. The SIM may include one or more pairs of unique identifiers and keys. Information may be stored on a particular chip or combinations of chips, the computer-readable medium 104, or otherwise.

The user device 102 is configured to communicate over a network interface 108. The network interface 108 may be configure with a radio or other electromagnetic spectrum transceiver. The network interface 108 may be combined with a SIM, and identification numbers (e.g., international mobile subscriber identity, local area identity) and keys therein (e.g., kᵢ), for secure communications.

The user device 102 may communicate with the computing device 122 over a network 130. Such communication paths may include wired communication technologies, wireless communication technologies, or combinations thereof. Wireless communication technologies may include various 3GPP standards (e.g., 4G LTE, 5G New Radio (NR), etc.) and Institute of Electrical and Electronics Engineers (IEEE) standards (e.g., 802.11g, 802.11n, 802.11ac, 802.11ax, 802.11be, etc.). Wired communication technologies may include various IEEE standards (e.g., 802.3). While various communication technologies and standards are contemplated herein, various communication mediums (e.g., wire, air), standards making bodies (e.g., 3GPP, IETF, IEEE), and protocols are contemplated herein.

FIG. 1B shows an example communications system 101. The communications system 101 may be a multiple access system that provides content, such as voice, data, video, messaging, broadcast, etc., to multiple wireless users. The communications system 101 may enable multiple wireless users to access such content through the sharing of system resources, including wireless bandwidth. For example, the communications systems 101 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1B, the communications system 101 may include user devices 102a, 102b, 102c, 102d, a radio access network (RAN) 118, a core network (CN) 119, a public switched telephone network (PSTN) 115, the Internet 117, and other networks 116, though it will be appreciated that any number of user devices, base stations, networks, and/or network elements are contemplated. Each of the user devices 102a, 102b, 102c, 102d may be any type of device configured to operate and/or communicate in a wireless environment. By way of example, the user devices 102a, 102b, 102c, 102d, any of which may be referred to as a station (STA), may be configured to transmit and/or receive wireless signals and may include a user equipment (UE), a wireless transmit/receive unit (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, an industrial device and applications (e.g., a robot and/or other wireless devices operating in an industrial and/or an automated processing chain contexts), a consumer electronics device, a device operating on commercial and/or industrial wireless networks, and the like. Any of the user devices 102a, 102b, 102c and 102d may be interchangeably referred to as a UE.

The communications systems 101 may also include a base station 114a and/or a base station 114b. Each of the base stations 114a, 114b may be any type of device configured to wirelessly interface with at least one of the user devices 102a, 102b, 102c, 102d to facilitate access to one or more communication networks, such as the CN 119, the Internet 117, and/or the other networks 116. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 118, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, the base station 114a may include three transceivers, i.e., one for each sector of the cell. The base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the user devices 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 101 may be a multiple access system and may employ one or more channel access schemes, such as CDMA, TDMA, FDMA, OFDMA, SC-FDMA, and the like. For example, the base station 114a in the RAN 118 and the user devices 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

The base station 114a and the user devices 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

The base station 114a and the user devices 102a, 102b, 102c may implement a radio technology such as NR Radio Access, which may establish the air interface 116 using NR.

The base station 114a and the user devices 102a, 102b, 102c may implement multiple radio access technologies. For example, the base station 114a and the user devices 102a, 102b, 102c may implement LTE radio access and NR radio access together, for instance using dual connectivity (DC) principles. Thus, the air interface utilized by user devices 102a, 102b, 102c may be characterized by multiple types of radio access technologies and/or transmissions sent to/from multiple types of base stations (e.g., an eNB and a gNB).

The base station 114a and the user devices 102a, 102b, 102c may implement radio technologies such as IEEE 802.11 (i.c., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1B may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. The base station 114b and the user devices 102c, 102d may implement a radio technology such as IEEE 802.11 to establish a wireless local area network (WLAN). The base station 114b and the user devices 102c, 102d may implement a radio technology such as IEEE 802.15 to establish a wireless personal area network (WPAN). The base station 114b and the user devices 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1B, the base station 114b may have a direct connection to the Internet 117. Thus, the base station 114b may not be required to access the Internet 117 via the CN 119.

The RAN 118 may be in communication with the CN 119, which may be any type of network configured to provide voice, data, applications, and/or voice over internet protocol (VOIP) services to one or more of the user devices 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 119 may provide call control, billing services, mobile location-based services, pre-paid calling, Internet connectivity, video distribution, etc., and/or perform high-level security functions, such as user authentication. Although not shown in FIG. 1B, it will be appreciated that the RAN 118 and/or the CN 119 may be in direct or indirect communication with other RANs that employ the same RAT as the RAN 118 or a different RAT. For example, in addition to being connected to the RAN 118, which may be utilizing a NR radio technology, the CN 119 may also be in communication with another RAN (not shown) employing a GSM, UMTS, CDMA 2000, WiMAX, E-UTRA, or WiFi radio technology.

The CN 119 may also serve as a gateway for the user devices 102a, 102b, 102c, 102d to access the PSTN 115, the Internet 117, and/or the other networks 116. The PSTN 115 may include circuit-switched telephone networks that provide plain old telephone service (POTS). The Internet 117 may include a global system of interconnected computer networks and devices that use common communication protocols, such as the transmission control protocol (TCP), user datagram protocol (UDP) and/or the internet protocol (IP) in the TCP/IP internet protocol suite. The networks 116 may include wired and/or wireless communications networks owned and/or operated by other service providers. For example, the networks 116 may include another CN connected to one or more RANs, which may employ the same RAT as the RAN 118 or a different RAT.

Some or all of the user devices 102a, 102b, 102c, 102d in the communications system 101 may include multi-mode capabilities (e.g., the user devices 102a, 102b, 102c, 102d may include multiple transceivers for communicating with different wireless networks over different wireless links). For example, the user device 102c shown in FIG. 1B may be configured to communicate with the base station 114a, which may employ a cellular-based radio technology, and with the base station 114b, which may employ an IEEE 802 radio technology.

FIG. 1C is a system diagram illustrating an example user device 102. As shown in FIG. 1C, the user device 102 may include a processor 133, a transceiver 131, a transmit/receive element 121, a speaker/microphone 125, a keypad 126, a display/touchpad 127, non-removable memory 129, removable memory 132, a power source 134, a global positioning system (GPS) chipset 136, and/or other peripherals 138, among others. It will be appreciated that the user device 102 may include any sub-combination of the foregoing elements.

The processor 133 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 133 may perform signal coding, data processing, power control, input/output processing, and/or any other functionality that enables the user device 102 to operate in a wireless environment. The processor 133 may be coupled to the transceiver 131, which may be coupled to the transmit/receive element 121. While FIG. 1C depicts the processor 133 and the transceiver 131 as separate components, it will be appreciated that the processor 133 and the transceiver 131 may be integrated together in an electronic package or chip.

The transmit/receive element 121 may be configured to transmit signals to, or receive signals from, a base station (e.g., the base station 114a) over the air interface 116. For example, the transmit/receive element 121 may be an antenna configured to transmit and/or receive RF signals. The transmit/receive element 121 may be an emitter/detector configured to transmit and/or receive IR, UV, or visible light signals, for example. The transmit/receive element 121 may be configured to transmit and/or receive both RF and light signals. It will be appreciated that the transmit/receive element 121 may be configured to transmit and/or receive any combination of wireless signals.

Although the transmit/receive element 121 is depicted in FIG. 1C as a single element, the user device 102 may include any number of transmit/receive elements 121. More specifically, the user device 102 may employ MIMO technology. Thus, the user device 102 may include two or more transmit/receive elements 121 (e.g., multiple antennas) for transmitting and receiving wireless signals over the air interface 116.

The transceiver 131 may be configured to modulate the signals that are to be transmitted by the transmit/receive element 121 and to demodulate the signals that are received by the transmit/receive element 121. As noted above, the user device 102 may have multi-mode capabilities. Thus, the transceiver 131 may include multiple transceivers for enabling the user device 102 to communicate via multiple RATs, such as NR and IEEE 802.11, for example.

The processor 133 of the user device 102 may be coupled to, and may receive user input data from, the speaker/microphone 125, the keypad 126, and/or the display/touchpad 127 (e.g., a liquid crystal display (LCD) display unit or organic light-emitting diode (OLED) display unit). The processor 133 may also output user data to the speaker/microphone 125, the keypad 126, and/or the display/touchpad 127. In addition, the processor 133 may access information from, and store data in, any type of suitable memory, such as the non-removable memory 129 and/or the removable memory 132. The non-removable memory 129 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 133 may access information from, and store data in, memory that is not physically located on the user device 102, such as on a server or a home computer (not shown).

The processor 133 may receive power from the power source 134, and may be configured to distribute and/or control the power to the other components in the user device 102. The power source 134 may be any suitable device for powering the user device 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 133 may also be coupled to the GPS chipset 136, which may be configured to provide location information (e.g., longitude and latitude) regarding the current location of the user device 102. In addition to, or in lieu of, the information from the GPS chipset 136, the user device 102 may receive location information over the air interface 116 from a base station (e.g., base stations 114a, 114b) and/or determine its location based on the timing of the signals being received from two or more nearby base stations. It will be appreciated that the user device 102 may acquire location information by way of any suitable location-determination method.

The processor 133 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The user device 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 133). The user device 102 may include a half-duplex radio for which transmission and reception of some or all of the signals (e.g., associated with particular subframes for either the UL (e.g., for transmission) or the DL (e.g., for reception)).

The user device 102 described in FIGs. A-E may perform one or more methods for the steering mode selection based on the location and mobility of the user device 102. For example, a user device 102 may receive a network policy from a policy management function (PCF) or a network node/server managing the network policy. The network policy may be received at the user device 102 through a base station 160a-c, 180a-c or an access point 250. The network polity may include ATSSS rules. The network policy or the ATSSS rule may include one or more steering modes. The steering mode may determine how data traffic (e.g., UDP flow, IP flow, QUIC flow, MPTCP flow, and/or MPQUIC flow) may be distributed across one or more network (e.g., 3GPP network and/or non-3GPP network). The steering modes may include an active-standby mode, a smallest delay mode, a load-balancing mode, a priority-based mode, and a redundant mode as described above. The network policy may further include an identifier indicating a boundary associated with the network policy or the user device 102. The boundary may be a set of coordinates (e.g., GPS coordinates) defining the boundary. The boundary may be defined by pixels of an area of an image.

The user device 102 may determine a vector parameter based on the directional movement of the user device 102. The directional movement of the user device 102 may include, but are not limited to, a speed (e.g., five feet per second), a direction of the movement, an angle of the movement, or the like. The user device 102 may determine, based on the steering mode and the vector parameter, which network the user device 102 uses to send the data. For example, when the steering mode is the active-standby mode (e.g., active for non-3GPP network and standby for 3GPP network) and the vector parameter indicate that the directional movement of the user device 102 is toward the 3GPP network, the user device 102 may initiate a handover process to transfer data traffics from the non-3GPP network to the 3GPP network. The user device 102 may also use the identifier indicating a boundary to determine which network the user device 102 uses to send the data. For example, when the vector parameter indicates that the user device 102 enters or leaves the boundary indicated by the identifier or the user device 102 anticipates, based on the vector parameter and the identifier indicating the boundary, that the user device 102 will intersect the boundary, the user device 102 may initiate, based on the steering mode, a handover process to transfer data traffics from the non-3GPP network to the 3GPP network or vice versa.

FIG. 1D is a system diagram illustrating the RAN 118 and the CN 119. As noted above, the RAN 118 may employ an E-UTRA radio technology to communicate with the user devices 102a, 102b, 102c over the air interface 116. The RAN 118 may also be in communication with the CN 119.

The RAN 118 may include eNode-Bs 160a, 160b, 160c, though it will be appreciated that the RAN 118 may include any number of eNode-Bs. The eNode-Bs 160a, 160b, 160c may each include one or more transceivers for communicating with the user devices 102a, 102b, 102c over the air interface 116. The eNode-Bs 160a, 160b, 160c may implement MIMO technology. Thus, the eNode-B 160a, for example, may use multiple antennas to transmit wireless signals to, and/or receive wireless signals from, the user device 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1D, the eNode-Bs 160a, 160b, 160c may communicate with one another over an X2 interface.

The CN 119 shown in FIG. 1D may include a mobility management entity (MME) 162, a serving gateway (SGW) 164, and a packet data network (PDN) gateway (PGW) 166. While the foregoing elements are depicted as part of the CN 119, it will be appreciated that any of these elements may be owned and/or operated by an entity other than the CN operator.

The MME 162 may be connected to each of the eNode-Bs 160a, 160b, 160c in the RAN 118 via an S1 interface and may serve as a control node. For example, the MME 162 may be responsible for authenticating users of the user devices 102a, 102b, 102c, bearer activation/deactivation, selecting a particular serving gateway during an initial attach of the user devices 102a, 102b, 102c, and the like. The MME 162 may provide a control plane function for switching between the RAN 118 and other RANs (not shown) that employ other radio technologies, such as GSM and/or WCDMA.

The SGW 164 may be connected to each of the eNode Bs 160a, 160b, 160c in the RAN 118 via the S1 interface. The SGW 164 may generally route and forward user data packets to/from the user devices 102a, 102b, 102c. The SGW 164 may perform other functions, such as anchoring user planes during inter-eNode B handovers, triggering paging when DL data is available for the user devices 102a, 102b, 102c, managing and storing contexts of the user devices 102a, 102b, 102c, and the like.

The SGW 164 may be connected to the PGW 166, which may provide the user devices 102a, 102b, 102c with access to packet-switched networks, such as the Internet 117, to facilitate communications between the user devices 102a, 102b, 102c and IP-enabled devices.

The CN 119 may facilitate communications with other networks. For example, the CN 119 may provide the user devices 102a, 102b, 102c with access to circuit-switched networks, such as the PSTN 115, to facilitate communications between the user devices 102a, 102b, 102c and traditional land-line communications devices. For example, the CN 119 may include, or may communicate with, an IP gateway (e.g., an IP multimedia subsystem (IMS) server) that serves as an interface between the CN 119 and the PSTN 115. In addition, the CN 119 may provide the user devices 102a, 102b, 102c with access to the other networks 116, which may include other wired and/or wireless networks that are owned and/or operated by other service providers.

Although the user device is described in FIGS. 1A-1E as a wireless terminal, such a terminal may use (e.g., temporarily or permanently) wired communication interfaces with the communication network.

The other network 116 may be a WLAN. A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). The DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac, 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1E is a system diagram illustrating the RAN 118 and the CN 119. As noted above, the RAN 118 may employ an NR radio technology to communicate with the user devices 102a, 102b, 102c over the air interface 116. The RAN 118 may also be in communication with the CN 119.

The RAN 118 may include gNBs 180a, 180b, 180c, though it will be appreciated that the RAN 118 may include any number of gNBs. The gNBs 180a, 180b, 180c may each include one or more transceivers for communicating with the user devices 102a, 102b, 102c over the air interface 116. The gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the user device 102a. The gNBs 180a, 180b, 180c may implement carrier aggregation technology. For example, the gNB 180a may transmit multiple component carriers to the user device 102a (not shown). A subset of these component carriers may be on unlicensed spectrum while the remaining component carriers may be on licensed spectrum. The gNBs 180a, 180b, 180c may implement Coordinated Multi-Point (COMP) technology. For example, user device 102a may receive coordinated transmissions from gNB 180a and gNB 180b (and/or gNB 180c).

The user devices 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The user devices 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the user devices 102a, 102b, 102c in a standalone configuration and/or a non-standalone configuration. In the standalone configuration, user devices 102a, 102b, 102c may communicate with gNBs 180a, 180b, 180c without also accessing other RANs (e.g., such as eNode-Bs 160a, 160b, 160c). In the standalone configuration, user devices 102a, 102b, 102c may utilize one or more of gNBs 180a, 180b, 180c as a mobility anchor point. In the standalone configuration, user devices 102a, 102b, 102c may communicate with gNBs 180a, 180b, 180c using signals in an unlicensed band. In a non-standalone configuration user devices 102a, 102b, 102c may communicate with/connect to gNBs 180a, 180b, 180c while also communicating with/connecting to another RAN such as eNode-Bs 160a, 160b, 160c. For example, user devices 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for user devices 102a, 102b, 102c and gNBs 180a, 180b, 180c may provide additional coverage and/or throughput for servicing user devices 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1E. the gNBs 180a, 180b, 180c may communicate with one another over an Xn interface.

The CN 119 shown in FIG. 1E may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 119, it will be appreciated that any of these elements may be owned and/or operated by an entity other than the CN operator.

The AMF 182a, 182b may be connected to one or more of the gNBs 180a, 180b, 180c in the RAN 118 via an N2 interface and may serve as a control node. For example, the AMF 182a, 182b may be responsible for authenticating users of the user devices 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for user devices 102a, 102b, 102c based on the types of services being utilized user devices 102a, 102b, 102c. For example, different network slices may be established for different use cases such as services relying on ultra-reliable low latency (URLLC) access, services relying on enhanced massive mobile broadband (cMBB) access, services for MTC access, and the like. The AMF 182a, 182b may provide a control plane function for switching between the RAN 118 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 119 via an N11 interface. The SMF 183a, 183b may also be connected to a UPF 184a, 184b in the CN 119 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 118 via an N3 interface, which may provide the user devices 102a, 102b, 102c with access to packet-switched networks, such as the Internet 117, to facilitate communications between the user devices 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring. and the like.

The CN 119 may facilitate communications with other networks. For example. the CN 119 may include, or may communicate with, an IP gateway (e.g., an IP multimedia subsystem (IMS) server) that serves as an interface between the CN 119 and the PSTN 115. In addition, the CN 119 may provide the user devices 102a, 102b, 102c with access to the other networks 116, which may include other wired and/or wireless networks that are owned and/or operated by other service providers. The user devices 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1E, and the corresponding description of FIGS. 1A-1E, one or more, or all, of the functions described herein with regard to one or more of: user device 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or user device functions.

Communications protocols contemplated herein may be connectionless or connection-based. For example, Transmission Control Protocol (TCP) may be used to establish state-based or connection-based communication between a client (e.g., user device 102), a computing device 122, or components, hops, nodes, instances, functions there between, or combinations thereof. A protocol may define header and payload information for packets of information. Headers may define various configurations and settings associated with the transmitted payload. User Datagram Protocol (UDP) may be similarly used to and configured to provide a connection-based protocol (e.g., QUIC). Other protocols (e.g., Datagram Congestion Control Protocol (DCCP)) are contemplated for use in accordance with one or more implementations of the present disclosure. Protocols may also include multipath versions (e.g., MPQUIC, MPDCCP, MPTCP, etc.).

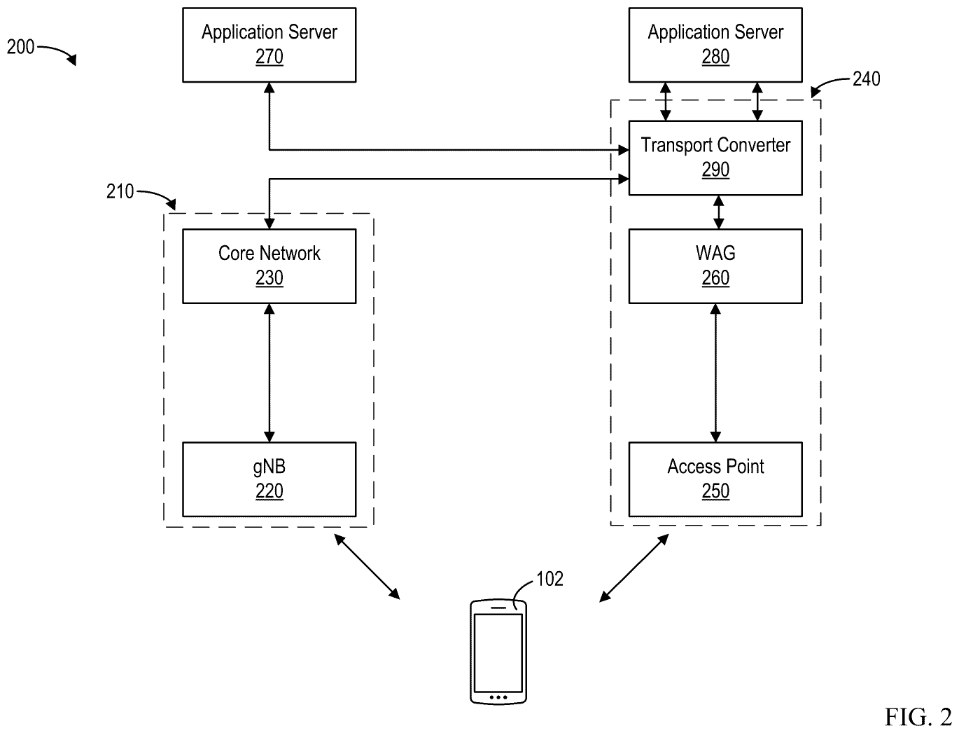

Referring to FIG. 2, a network 210 (e.g., a network operated by a first operator or network operator) may include wireless communication protocols between user device 102 and the cellular base station 220 (e.g., eNB, gNB, xNB, and the like), which may be part of a radio access network based on various radio access technologies. The base station 220 may be considered an origin of a connection because it is the outward facing node from the network 210 to the user device 102. That is, an origin may be a node of a network (e.g., network 210) that communicates with devices off of the network (e.g., user device 102, application server 270). The origin may be an edge node or device. The radio access network may be associated with a network. A network (e.g., public land mobile network (PLMN)) may maintain the radio access network and the associated core network 230. The network (e.g., an MNO) may issue subscriptions for the user device 102 to access the network 210. The network may include communications hardware and software to support various protocols and components (e.g., 3GPP 5G, IEEE 802.11, and the like). The terms MVNO, MSO, PLMN, MNO, and other operator indicators are intended for designation (e.g., first, second, third) to distinguish between different networks and are not intended to be rigid as terminology and scope of these and other terms is evolving in the field.

Another communication path may be established between user device 102 and transport converter 290 over a network 240 (e.g., a network operated by a second operator or network operator) having a Wi-Fi or IEEE 802.11 access point 250. The transport converter 290 may run on the computer device 122. The access point 250 may be configured to communicate with a wireless access gateway 260. The access point 250 may be considered an origin of a connection because it is the outward facing node from the network 240 to the user device 102. That is, an origin may be a node of a network (e.g., network 240) that communicates with devices off of the network (e.g., user device 102, application server 270). The wireless access gateway 260 may route data packets from the access point 250 to the network 130. A network (e.g., an MSO) may maintain the access point 250 and the associated wireless access gateway 260. The network may issue subscriptions for the user device 102 to access one or more of the networks (e.g., network 210, network 240). The subscriptions may be issued in packages (e.g., subscription packages) and stored or unpacked on a SIM, an embedded SIM, or otherwise. The network associated with the access point 250 may be different than the network associated with the radio access network.

A communication path may be defined by the individual hops made alone the path between components, instances, functions, servers, and interfaces. A path may be unique in that the set of hops are unique. For example, a path comprising hopes between A, B, and C may be considered unique from a path that consists of A and B or a path that comprises A, B, and D. A network may be defined as a set of components, instances, functions, servers, interfaces, other implements and combinations thereof that are configured to communicate or have access to communicate with one another. The network may comprise those components, instances, functions, servers, interfaces, other implements and combinations that are managed by a network provider and configured to communicate. A network may be a logical grouping of the set (e.g., subnet). A network may be virtually grouped logically (e.g., virtual private network) or contain portions that are virtually grouped logically.

The communication paths may include wired communication technologies, wireless communication technologies, or combinations thereof. Wireless communication technologies may include various 3GPP standards (e.g., 4G LTE, 5G NR, etc.) and Institute of Electrical and Electronics Engineers (IEEE) standards (e.g., 802.11g, 802.11n, 802.11ac, 802.11ax, 802.11be, etc.). Wired communication technologies may include various IEEE standards (e.g., 802.3). While various communication ,echnologies and standards are contemplated herein, various communication mediums (e.g., wire, air), standards making bodies (e.g., 3GPP, IETF, IEEE), and protocols are contemplated herein.

The core network 230 and wireless access gateway 260 are used as examples for context. It should be appreciated that standards may change the names of these entities as technologies improve and progress. The core network 230 and the wireless access gateway 260 may be configured to directly communicate over an interface. For example, an access and mobility function (AMF), session management function (SMF), policy control function (PCF), other functions or instances, or combinations thereof may perform some or all of the steps described herein. The computing device 122 may be configured to perform all or some of the steps described. For example, the computing device 122 may orchestrate SIM provisioning based on a location pattern, a quantity of time, data consumption, or combinations thereof according to the user device 102. The computing device 122 may be configured to send a request to the user device 102 to determine whether the user device 102 is interested in connecting over the MSO network with eSIM credentials. The computing device 122 may be or may be connected with a remote SIM provisioning system (SM-DP+). The user device 102 may connect with the computing device 122, through the computing device 122, or according to the computing device 122 to obtain the eSIM or eUICC.

The computing device 122 may be associated with either the network 210 or the network 240. The computing device 122 may be independent of the network 210 and the network 240. For example, the computing device 122 may serve as an intermediary, receiving data from the user device 102 over either of the networks 210, 240 or another network and providing a provisioning of the identifier and key. The identifier and the key may be pushed or pulled.

The computing device 122 may include instructions to serve as a proxy or proxy server (e.g., instructions for transport converter 290) for the plurality of paths formed between application servers 270, 280 and user device 102. For example, one or more application servers 270, 280 may be configured to send and receive communications with the computing device 122 based on communications from the user device 102 over one or more paths associated with networks 210, 240.

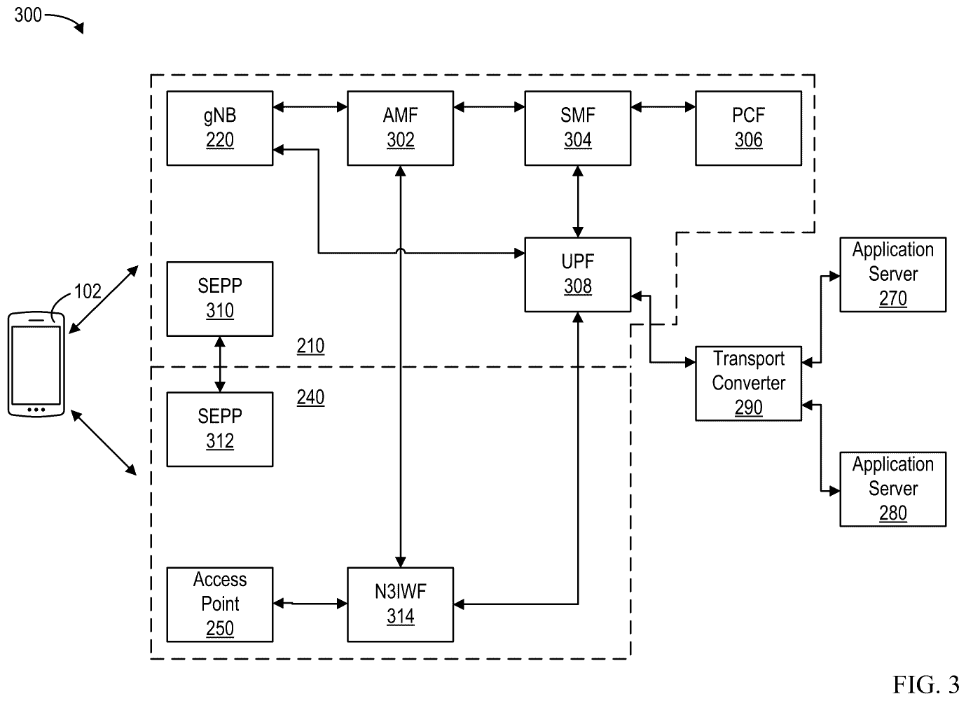

In FIG. 3, an example architecture 300 with an interworking function 314 in accordance with one or more implementations of the present disclosure is shown. The interworking function 314 may be connected with the user plane function 308 of network 240. The interworking function 314 may be associated with one or more of networks 210, 240. The interworking function 314 may provide the user device 102 access to the transport converter 290. The user plane functions 308 may be connected over an N9 interface. The N9 interface may be encapsulated by the connection provided by SEPP 310, 312. The policy control function 306 may be configured to communicate with the transport converter 290 over an N6 interface while each user plane function is individually connected with the transport converter 290 over respective interfaces. These interfaces may be an N6 interface, an Nx interface, or another applicable interface. As an example, the transport converter 290 may be part of a data network associated with a PLMN (e.g., network 210, 240). The data network may be separate from a voice network associated with either of the networks 210, 240. The transport converter 290 may be part of a network independent from either of the networks 210, 240 and hosted by a third party. As an example, the transport converter 290 may be provisioned on a cloud-computing server accessible over the Internet.

The access and mobility management function 302 is the entry function of the control plane and may connect to the core network. The access and mobility management function 302 may terminate the non-access stratum (NAS) of the user device 102. The access and mobility management function 302 may also perform access authentication for the user device 102 and mobility management. Additionally or alternatively, the access and mobility management function 302 may route session management messages to the one or more session management functions 304.

The session management function 304 may be responsible for termination of a session based on the session management function from the user device 102. The session management function 304 may allocate Internet Protocol addresses and provide control of the user plane function 308 (UPF). The session management function 304 may also terminate sessions associated with the policy control function 306 (PCF). The session management function 304 may communicate with the access and mobility management function 302 over the N11 interface and the policy control function 254 over the N7 interface.

The policy control function 306 may enable policy rules described herein and enable control functions for enforcement. These rules may be distributed and enforced at the user device 102 or other functions described herein. As an example, the policy control function 306 may enable route and slice selection.

The user plane function 308 may implement the packet forwarding and routing for user plane data in the role of the inter-radio access technology (RAT) and intra-RAT anchor. The user plane function 308 may also provide IP address allocation when instructed by the session management function 304 and can provide gating or downlink data buffering. The user plane function 308 may communicate with the session management function 304 over the N4 interface. The user plane function 308 may communicate with the data network associated with the application servers 270, 280 over an N6 interface. The application servers 270, 280 may be part of either network 210, 240 or available on the Internet or other data networks not associated with the network 210, 240.

In some circumstances, the interworking function 314 or other functions may be configured to authenticate with the network 210. For instance, user device 102 may include a credential circuit comprising authentication credentials for network 210. The user device 102 may include a credential circuit comprising authentication credentials (e.g., identifiers, keys, etc.) for network 240. The authentication credentials may provide cross-validation and access to either network 210, 240. For instance, the authentication credentials may be associated with network 240 and traverse the interworking function 314, providing access to network 240 from the user device 102. The same authentication credentials may indicate access, from network 240 to network 210. An indication may be provided from the network 240 to network 210 indicating that access is authorized without provided credentials specific to network 210. In such a way, access to network 210 may be achieved with authentication credentials for network 240 or vice versa. As an example in combination or separate, the authentication credentials may be based on an eSIM or embedded SIM associated with the user device 102. The authentication credentials may be issued by the network 240 associated with the interworking function 314. The authentication credentials may provide access to the network of the network 210.

The example architecture 300 may include an interworking function 314. The interworking function 314 may be a non-3GPP interworking function (N3IWF). The interworking function 314 may be associated with an access point 250 of one of the networks (e.g. network 240). Also shown is an interworking function 314 that may be associated with an access point 250 of the other of the networks (e.g., network 210). The interworking function 314 may provide access to 3GPP functions from a non-3GPP access point. As an example, the access point 250 may be configured to communicate over IEEE 802.11 or other protocols. For example, the access point 250 may be one or more hotspots associated with a public, corporate, or otherwise access network. The interworking function 314 may allow PDU session establishment and user plane functionalities (e.g., quality of service). In such away, the user device 102 may be configured to connect to a network having 3GPP functions (e.g., packet-switched gateways, user plane functions, etc.). For example, the interworking function 314 may provide user device 102 access to user plane function 308. As an example, the interworking function 314 may determine corresponding commands or instructions based on communications from the user device 102 sent over the access point 250 for translation to the user plane function 308.

As shown, the example architecture 300 may include respective networks 210, 240 having respective security edge protection proxies (SEPP) 310, 312. The SEPPs 310, 312 may provide for a path for signaling traffic across network. The communication between SEPPs 310, 312 may be authenticated and constituting all or part of an N32 interface. As an example, the user plane functions 308 may establish communications over an N9 interface. The N9 interface may be encapsulated by the SEPPs 310, 312 and sent over the N32 interface between the two networks 210, 240. Although shown as direct communication channels, all inter-PLMN communications may be transmitted through the N32 interface.

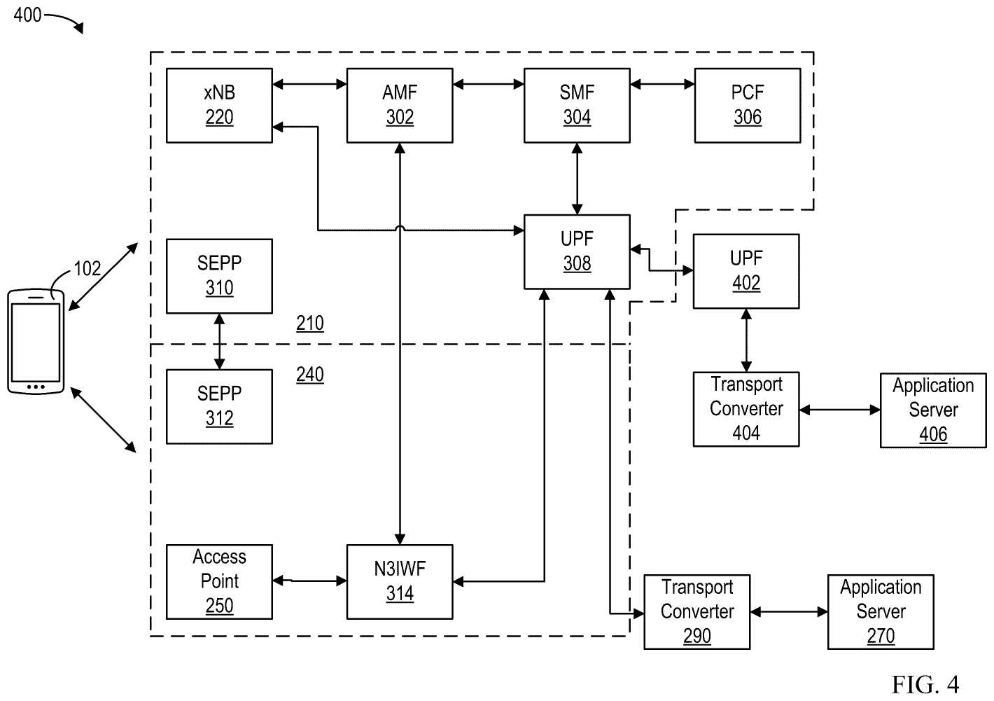

In FIG. 4, an example communication architecture 400 in accordance with one or more implementations of the present disclosure is shown. The architecture 400 includes the transport converter 290 on the edge of the network 210. The transport converter 290 may be located on the same network as network 210 or network 240 or a network that is operated by an operator of network 210 or network 240. A rule may exist to further direct traffic to another user plane function 402 and transport converter 404 that is located on a public cloud. The transport converter may be configured to communicate with another application server 406. The application server 406 may be on a public or private network.

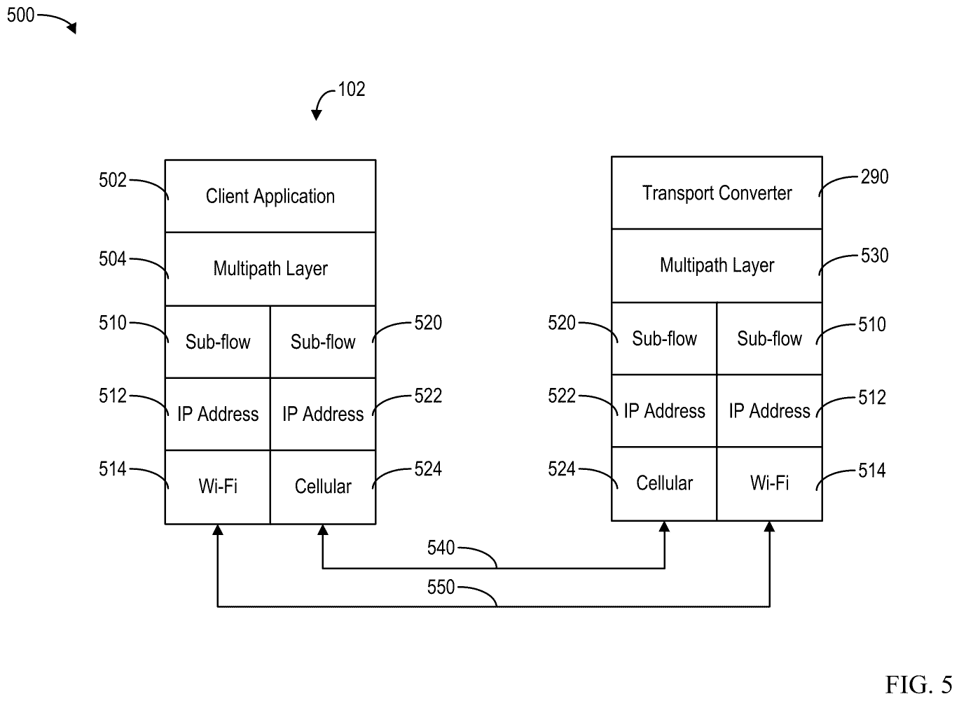

In FIG. 5, an example protocol stack 500 in accordance with one or more implementations of the present disclosure is shown. The protocol stack 500 may include a client application 502. The client application 502 may be a set of instructions that the user device 102 is operable to execute. The client application 502 may be configured to generate packet-based communications. The user device 102 may be configured to receive those packet-based communications and convert them to multipath communications with the multipath layer 504. The multipath layer 504 may create two subflows 510, 520. The subflows 510, 520 may be respectively assigned IP addresses 512, 522 according to respective communication mediums 514, 524. The data may traverse over more than one path 540, 550 to the receiving side with similar layers to that of the user device 102. A multipath layer 530 may convert (e.g., a transport converter) the received multipath communications into a single path for the server application 560 that does not support multipath communications. The transport converter may be based on a 0-RTT protocol (e.g., Internet Engineering Task Force (IETF) request for comment (RFC) 8803).

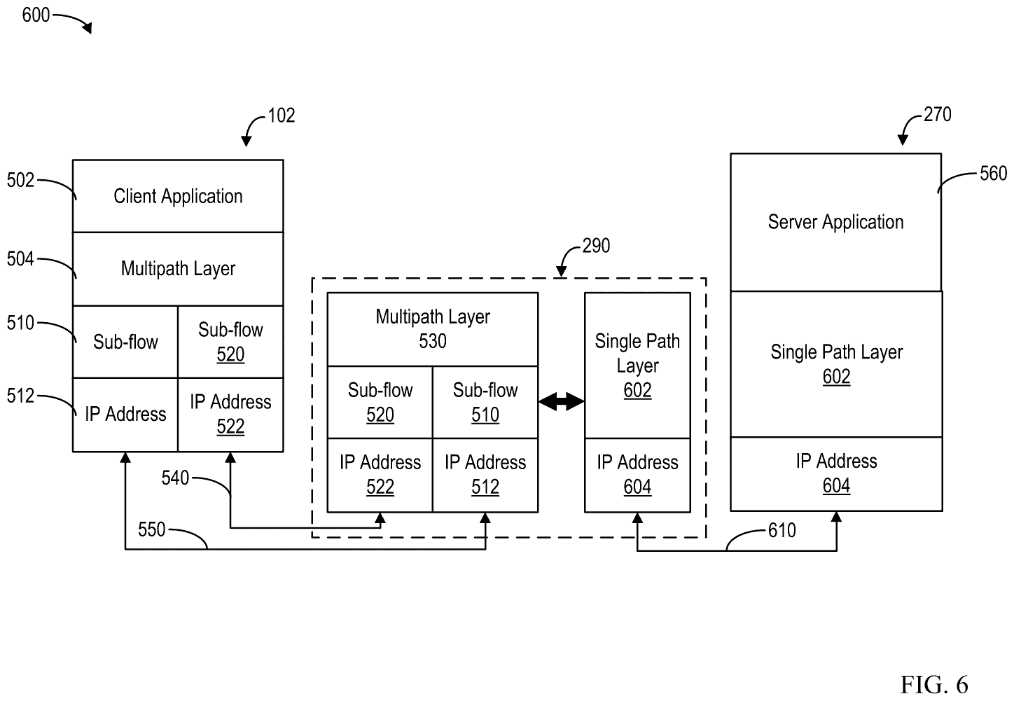

In FIG. 6, an example communication link 600 in accordance with one or more implementations of the present disclosure is shown. The communication link 600 may include one or more nodes (e.g., gNB 220, gateway 260) associated with one or more networks 210, 240 for establishing a connection between the transport converter 290, the user device 102, and the application server 270. The user device 102 may include instructions for executing a client application 502. The user device 102 may further include instructions for a multipath connection. A multipath connection may be based on multipath Transmission Control Protocol (MPTCP), multipath QUIC (MPQUIC), multipath Datagram Congestion Control Protocol (MPDCCP), another multipath protocol, or a combination thereof. An identifier may be assigned to designate the multipath connection. The multipath connection may include two subflows 510, 520 and be based on multipath layer 504 and multipath layer 530. The subflows 510, 520 may be identified based on a subflow sequence number. For example, the sequence numbers may be used to reassemble data sent over the multipath connection. For example, a data sequence mapping may be used to assemble data received over the path and data received over the path. The path 540 may comprise nodes or hops from network 210 (e.g., gNB 220, UPF 214) and the path 550 may comprise nodes or hops from network 240. Each subflow may have an individual IP address 512, 522. The paths may also include nodes or hops that are associated with the same network or intermingled.

The data may be assembled based on a data sequence mapping or map. The data sequence map may be based on a first subflow sequence number and a second subflow sequence number associated with each path, respectively. As such, the combination of the data from the path of the first network and the data of the path of the second network may be combined based on the data sequence mapping to establish ordered data without a loss of integrity. The response may be disassembled into portions and retransmitted over the respective paths to improve throughput and speed in a similar fashion.

The multipath connection may terminate at a computing device 122. The computing device 122 may include instructions to perform transport conversion by a transport converter 290. The transport converter 290 may be based on a 0-RTT protocol (e.g., Internet Engineering Task Force (IETF) request for comment (RFC) 8803). The transport converter 290 may be configured to convert the multipath connection into a single path connection according to single path layer 602. In such a way, the transport converter 290 may serve as a proxy between the user device 102 and the application server 270 and provide communications over multiple paths and subflows 510, 520. The single path 610 may terminate at a server application 560.

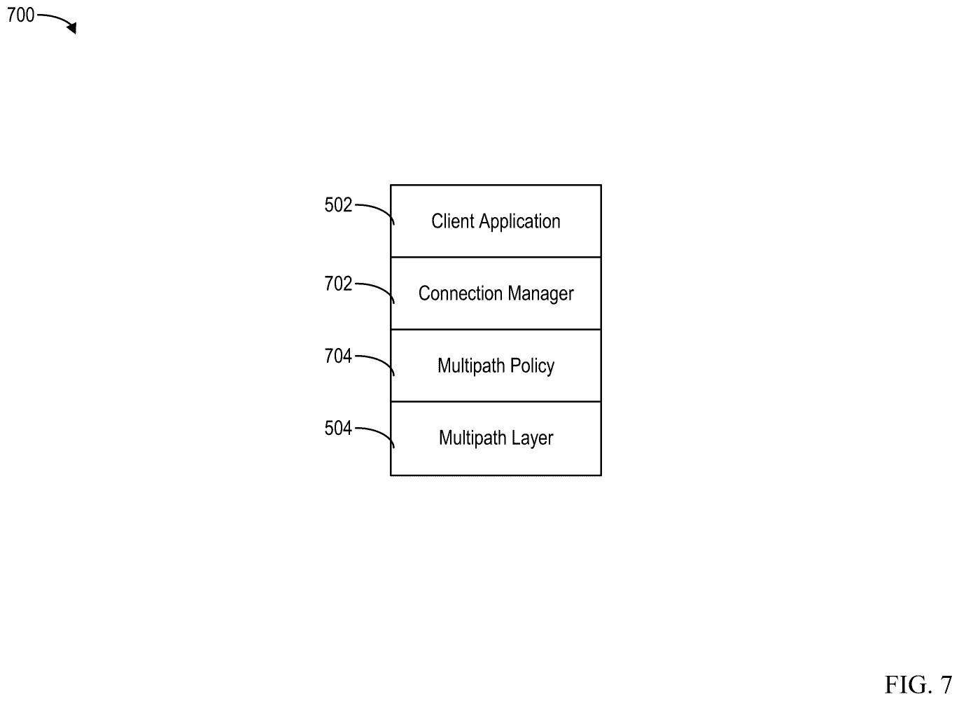

In FIG. 7, an example control framework 700 in accordance with one or more implementations of the present disclosure is shown. The framework may include the client application 502 associated with a connection manager 702. The connection manager 702 may include steering policies 704 (e.g., Access Traffic Steering, Switching & Splitting (ATSSS)) for connecting and disconnecting from a multipath communications. For example, the connection manager 702 may include a policy 704 that comprises rules related to the access point 250 or base station (e.g., gNB 220) of the networks 210, 240. The connection manager 702 may then control the multipath layer 504 and other elements of the Open Systems Interconnection (OSI) stack.

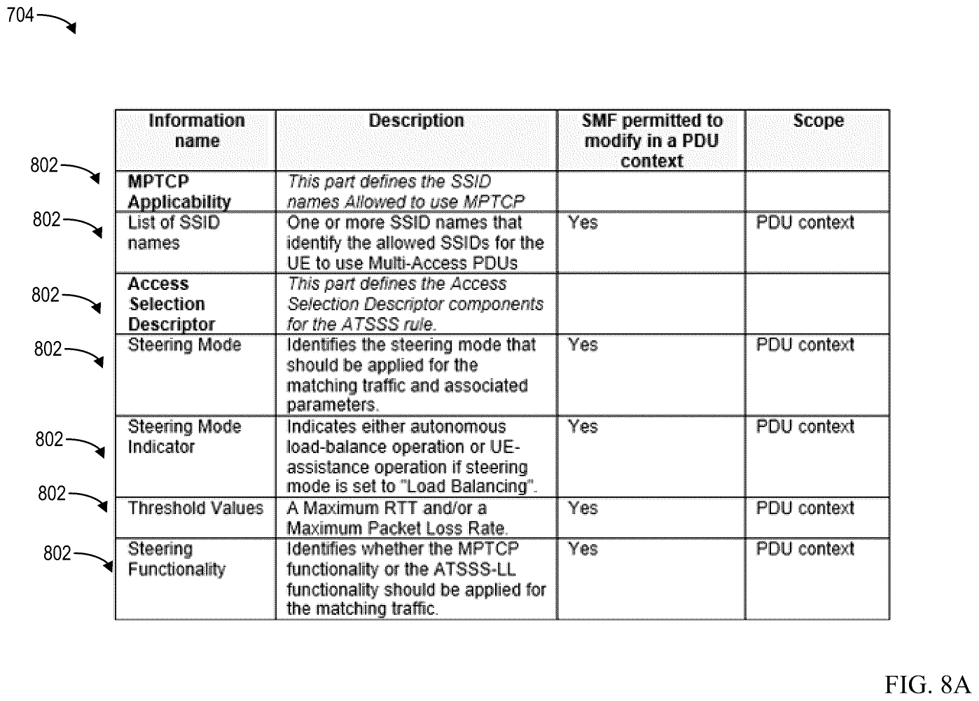

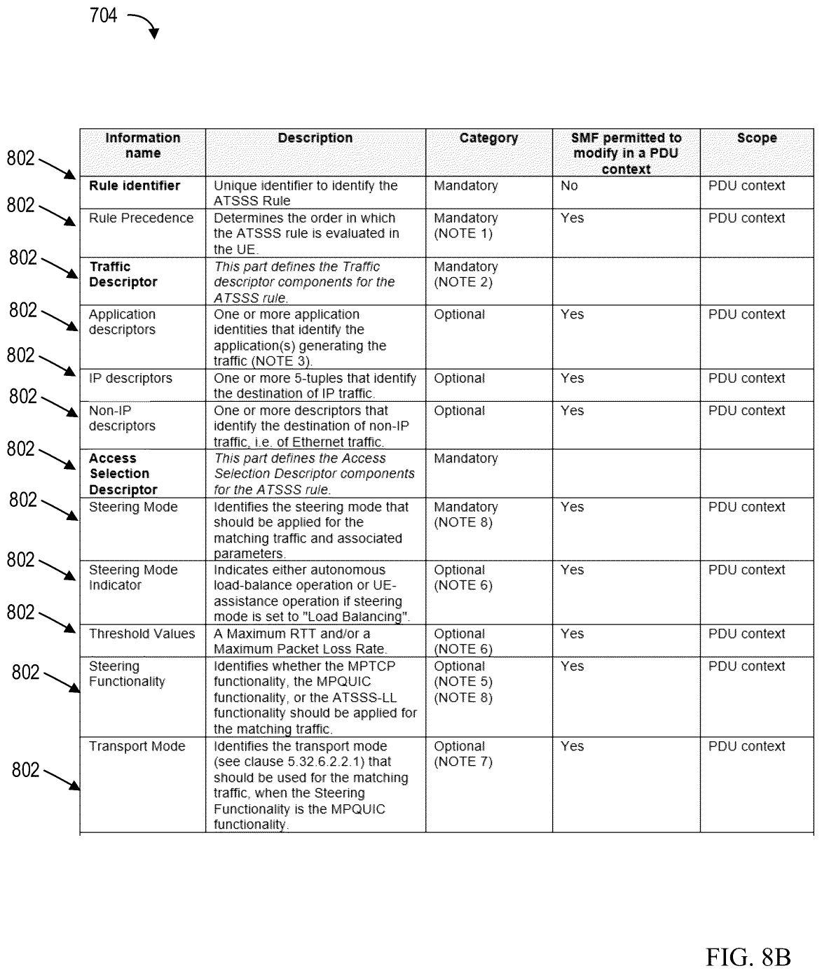

In FIG. 8A, an example policy 704 in accordance with one or more implementations of the present disclosure is shown. The policy 704 may include rules 802. For example, a rule of the rules 802 may be indicative of a mode. For example, the policy, rule, or portion thereof may be transmitted as text, a list, a dictionary, another data structure, or combination thereof (e.g., “Traffic Descriptor: UDP, DestAddr 1.2.3.4”, “Steering Mode: Active-Standby, Active=3GPP, Standby=non3GPP”) to the user device 102. The rule may include a parameter. The parameter may be based on a geolocation of user device 102.

For example, the parameter may be coordinates of the user device 102 relative a positioning system (e.g., global position system (GPS)). The parameter may also be a relative indication between those coordinates and an address (e.g., a distance from the address, a distance and a direction from the address) or another location. The parameter may also be a relative indication between two coordinates of the user device 102 over time. For example, the parameter may be a scalar (e.g., speed), a vector (e.g., velocity), or another physical sensory indication associated with the user device 102 (e.g., temperature, acceleration, camera image, microphone capture). For example, the temperature may be used to indicate whether the user device 102 is inside (e.g., temperatures within a range (e.g., 60°-80°) and outside (e.g., all other temperatures or another range). The parameter may be an aggregate value. For example, the parameter may be an average of coordinates over a duration or another statistical analysis of the parameter over a duration. The parameter may further be an average of speed, or another sensory indication, over a duration.

The rule may be indicative of which parameter the rule is to be evaluated against. For example, the rule may indicate the name of the parameter (e.g., speed, coordinate, etc.), the acceptable values for the parameter (e.g., less than five meters per second, within the boundary, near the boundary), and the action to take (e.g., enable mode) when the constraint or threshold is satisfied.

In FIG. 8B, an example policy 704 in accordance with one or more implementations of the present disclosure is shown. The policy 704 may include ATSSS rules 802. After the establishment of a multi-access (MA) PDU session, the user device 102 may receive a prioritized list of ATSSS rules 802 from the network 210 (e.g., SMF 304). The user device 102 may evaluate the ATSSS rules 802 in priority order. Each ATSSS rule 802 may include a Traffic Descriptor that determines when the rule is applicable. An ATSSS rule 802 may be determined to be applicable when every component in the Traffic Descriptor matches the considered data traffic (e.g., service data flow (SDF)). Depending on the type of the MA PDU Session, the Traffic Descriptor may include: (1) for IPV4, or IPv6, or IPv4v6 type, Application descriptors and/or IP descriptors; and (2) tor Ethernet type, Application descriptors and/or Non-IP descriptors. One ATSSS rule 802 with a “match all” Traffic Descriptor may be provided, which matches all SDFs. When provided, it may have the least Rule Precedence value, so it may be the last one evaluated by the user device 102.

Each ATSSS rule 802 may include an Access Selection Descriptor that comprises a steering mode, a steering mode indicator, threshold values, a steering functionality, and a transport mode.

The steering mode may determine how the traffic of the matching data flow may be distributed across 3GPP (e.g., network 210) and non-3GPP accesses (e.g., network 240). The steering modes may include, but are not limited to: an active-standby mode, a smallest delay mode, a load-balancing mode, a priority-based mode, and a redundant mode. The active-standby mode may be used to steer a data flow on one access (e.g., the active access) when this active access is available, and to switch the data flow to the available other access (e.g., the standby access) when the active access becomes unavailable. When the active access becomes available again, the data flow may be switched back to this access. If the standby access is not defined, then the data flow may be only allowed on the active access and cannot be transferred on another access.

The smallest delay mode may be used to steer a data flow to the access that is determined to have the smallest Round-Trip Time (RTT). Measurements may be obtained by the user device 102 and UPF 308 to determine the RTT over 3GPP access (e.g., network 210) and over non-3GPP access (e.g., network 240). In addition, if one access becomes unavailable, all data flow traffic may be switched to the other available access. The load-balancing mode may be used to split a data flow across both accesses if both accesses are available. It may include the percentage of the data flow traffic that can be sent over 3GPP access (e.g., network 210) and over non-3GPP access (e.g., network 240). In addition, if one access becomes unavailable, all data flow traffic may be switched to the other available access, as if the percentage of the data flow traffic transported via the available access was 100%.

The priority-based mode may be used to steer all the traffic of an data flow to the high priority access, until this access is determined to be congested. In this case, the traffic of the data flow may be sent to the low priority access. For example, the data flow traffic may be split over the two accesses. In addition, when the high priority access becomes unavailable, all data flow traffic may be switched to the low priority access. The redundant mode (without threshold values) may be used to duplicate traffic of an data flow on both accesses if both accesses are available. A primary access (either 3GPP access or Non-3GPP access) may be provided to the user device 102 in the ATSSS rules 802 and to the UPF 308. If a primary access is provided, the user device 102 and UPF 308 may send all data packets of the data flow on the primary access and may duplicate data packets of the data flow on the other access. If the primary access is not provided to the user device 102 and UPF 308, the user device 102 and UPF 308 may send all data packets of the data flow on both accesses.

A steering mode indicator may indicate that the user device 102 may change the default steering parameters provided in the steering mode component and may adjust the traffic steering based on its own decisions. Steering mode indicators may comprise autonomous load-balance indicator and user device assistance indicator. The autonomous load-balance indicator may be provided when the steering mode is load-balancing. When provided, the user device 102 may ignore the percentages in the steering mode component (i.e. the default percentages provided by the network) and may autonomously determine its own percentages for traffic splitting, in a way that maximizes the aggregated bandwidth in the uplink direction. The user device 102 may be expected to determine its own percentages for traffic splitting by performing measurements across the two accesses. The UPF 308 may apply a similar behavior when the autonomous load-balance indicator is included in an N4 rule. UE

User device assistance indicator may be provided when the steering mode is load-balancing. When provided by the network, it may indicate that: (a) the user device 102 may decide how to distribute the UL traffic of the matching data flow based on the user device's internal state (e.g. when the user device 102 is in the special internal state, e.g. lower battery level), and that (b) the user device 102 may inform the UPF 308 how it decided to distribute the UL traffic of the matching data flow. In the normal cases, although with this indicator provided, the user device 102 may distribute the UL traffic as indicated by the network. The user device-assistance indicator can be provided for data flows for which the network has no strong steering requirements. For example, when the network has no strong steering requirements for the default traffic of an MA PDU session, the network can indicate (i) that this traffic needs to be steered with load-balancing steering mode using 50%-50% split percentages, and (ii) that the user device 102 is allowed to use other split percentages, such as 0%-100%, if this is needed by the user device 102 to optimize its operation (e.g. to minimize its battery consumption).

One or more threshold values may be provided when the steering mode is priority-based or when the steering mode is load-balancing with fixed split percentages (i.e. without the autonomous load-balance indicator or user device assistance indicator). One threshold value may be provided when the steering mode is the redundant mode. A threshold value may be either a value for RTT or a value for packet loss rate. The threshold values may be applicable to both accesses and may be applied by the user device 102 and UPF 308. For load-balancing steering mode with fixed split percentages (i.e. without the autonomous load-balance indicator or user device assistance indicator), when at least one measured parameter (i.e., RTT or packet loss rate) on one access exceeds the provided threshold value, the user device 102 and UPF 308 may stop sending traffic on this access, or may continue sending traffic on this access, but may reduce the traffic on this access by a predetermined amount and may send the amount of reduced traffic on the other access. When all measured parameters (i.e., RTT and packet loss rate) for both accesses do not exceed the provided threshold values, the user device 102 and UPF 308 may apply the fixed split percentages.

For priority-based steering mode, when one or more threshold values are provided for the priority-based steering mode, these threshold values may be considered by user device 102 and UPF 308 to determine when an access becomes congested. For example, when a measured parameter (i.e., RTT or packet loss rate) on one access exceeds the provided threshold value, the user device 102 and UPF 308 may consider this access as congested and send the traffic to the low priority access. For the redundant steering mode, when the measured packet loss rate exceeds the provided threshold value on both accesses, the user device 102 and UPF 308 may duplicate the traffic of the data flow on both accesses. When the measured RTT exceeds the provided threshold value on both accesses, the user device 102 and UPF 308 may duplicate the traffic of the data flow on both accesses based on implementation. When the measured parameter (i.e., either RTT or packet loss rate) exceeds the provided threshold value on one access only. the user device 102 and UPF 308 may send the traffic of the data flow over the other access. When the measured parameter (i.e., either RTT or packet loss rate) does not exceed the provided threshold value on any access, the user device 102 and UPF 308 may send the traffic of the data flow over the primary access. The primary access (either 3GPP access or Non-3GPP access) may be provided to the user device 102 in the ATSSS rules 802 and to the UPF 308 in the N4 rules. If the primary access is not provided to the user device 102 and UPF 308, user device 102 and UPF 308 may select a primary access, for example, based on using the lowest RTT access or the lowest packet loss rate access. If measurement results on an access are not available for a parameter, it may be considered that the measured parameter for this access has not exceeded the provided threshold value.

A steering functionality may identify whether the MPTCP functionality, or the MPQUIC functionality, or the ATSSS-LL functionality may be used to steer the traffic of the matching data flow. This may be used when the user device 102 supports multiple functionalities for ATSSS. A transport mode may identify the transport mode that may be applied by the MPQUIC functionality for the matching traffic.

As an example, the following ATSSS rules 802 may be provided to the user device 102:

“Traffic Descriptor: UDP. DestAddr 1.2.3.4”, “Steering Mode: Active-Standby, Active=3GPP, Standby=non-3GPP”: This rule may indicate “steer UDP traffic with destination IP address 1.2.3.4 to the active access (3GPP), if available. If the active access is not available, use the standby access (non-3GPP).”

“Traffic Descriptor: TCP. DestPort 8080”. “Steering Mode: Smallest Delay”: This rule may indicate “steer TCP traffic with destination port 8080 to the access with the smallest delay”. The user device 102 may need to measure the RTT over both accesses, in order to determine which access has the smallest delay.

“Traffic Descriptor: TCP traffic of Application-1”, “Steering Mode: Load-Balancing. 3GPP=20%, non-3GPP=80%”, “Steering Functionality: MPTCP”: This rule may indicate “send 20% of the TCP traffic of Application-1 to 3GPP access and 80% to non-3GPP access by using the MPTCP functionality.”

“Traffic Descriptor: TCP traffic of Application-1”. “Steering Mode: Load-Balancing, 3GPP=20%, non-3GPP=80%, “Threshold Value for Packet Loss Rate: 1%”, “Steering Functionality: MPTCP”: This rule may indicate “send 20% of the TCP traffic of Application-1 to 3GPP access and 80% to non-3GPP access as long as the packet loss rate does not exceed 1% on both accesses, by using the MPTCP functionality. If the measured packet loss rate of an access exceeds 1%, then the TCP traffic of Application-1 may be reduced on this access and sent via the other access.”

“Traffic Descriptor: UDP traffic of Application-1”, “Steering Mode: Load-Balancing, 3GPP=30%, non-3GPP-70%”, “Steering Functionality: MPQUIC”, “Transport Mode: Datagram mode 1”: This rule may indicate “send 30% of the UDP traffic of Application-1 to 3GPP access and 70% to non-3GPP access by using the MPQUIC functionality with the Datagram mode 1.”

“Traffic Descriptor: com.example.app0, TCP”, “Steering Mode: Redundant”, “Steering Functionality: MPTCP”: This rule may indicate “traffic duplication is applied by the MPTCP steering functionality to the TCP traffic of application com.example.app0 and 100% of the traffic is duplicated over both accesses.”

“Traffic Descriptor: com.example.app1. TCP”, “Steering Mode: Redundant, Primary Access=3GPP, Threshold Value for Packet Loss Rate: 0.1%”, “Steering Functionality: MPTCP”: This rule may indicate “traffic duplication is applied to the TCP traffic of application com.example.app1. If the measured PLR exceeds 0.1% on both accesses, all matched traffic may be duplicated on both accesses. If the measured PLR exceeds 0.1% on one access only (either 3GPP or non-3GPP access), all matched traffic may be sent over the other access only. If the measured PLR does not exceed 0.1% on any access, all matched traffic may be sent over 3GPP access only as this is the primary access.”

“Traffic Descriptor: com.example.app2, TCP”, “Steering Mode: Redundant, Threshold Value for Packet Loss Rate: 0.1%”, “Steering Functionality: MPTCP”. This rule may indicate “traffic duplication is applied to the TCP traffic of application com.example.app2. If the measured PLR exceeds 0.1% on both accesses, all matched traffic may be duplicated and transmitted on both accesses. If the measured PLR exceeds 0.1% on one access only (either 3GPP or non-3GPP access), all matched traffic may be sent over the other access only. If the measured PLR does not exceed 0.1% on any access, the user device 102 or UPF 308 may select the access based on their own implementation, for example, the access with lower packet loss rate to transmit all matched traffic.”

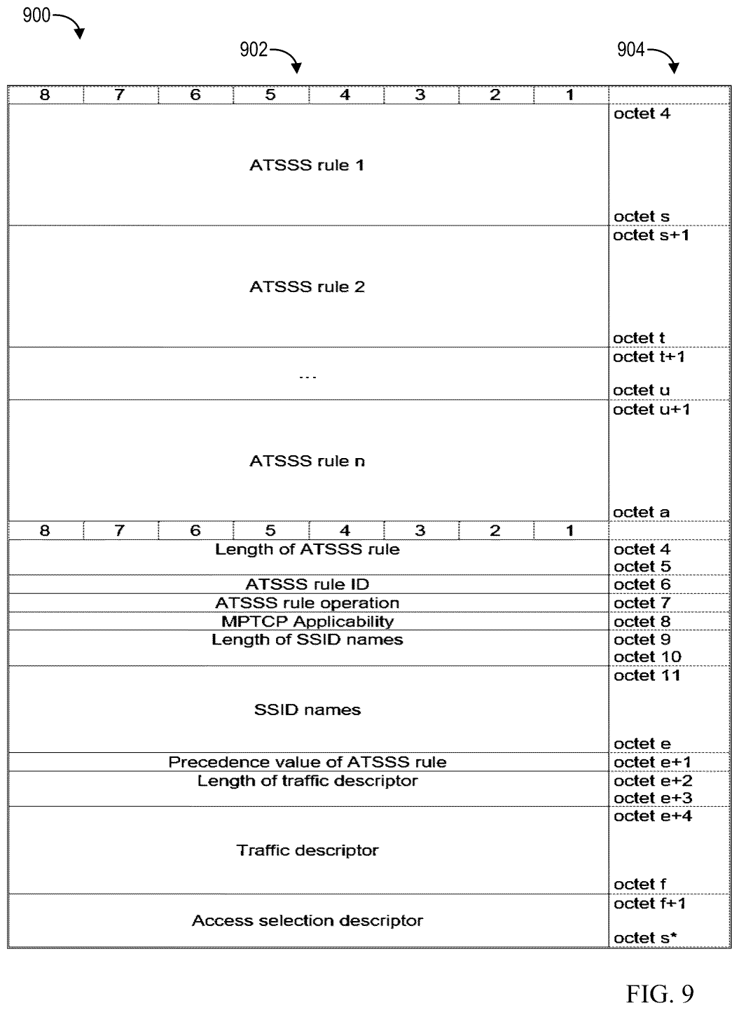

In FIG. 9, an example encoding 900 accordance with one or more implementations of the present disclosure is shown. The encoding 900 shows how a policy 704 may be transmitted to the user device 102 or node. For example, the policy 704 may include steering rules (e.g., one or more of rules 802) and a multipath rule (e.g., MPTCP applicability) in a particular octet. The multipath rule may be situated in any octet and may be defined according to a standard.

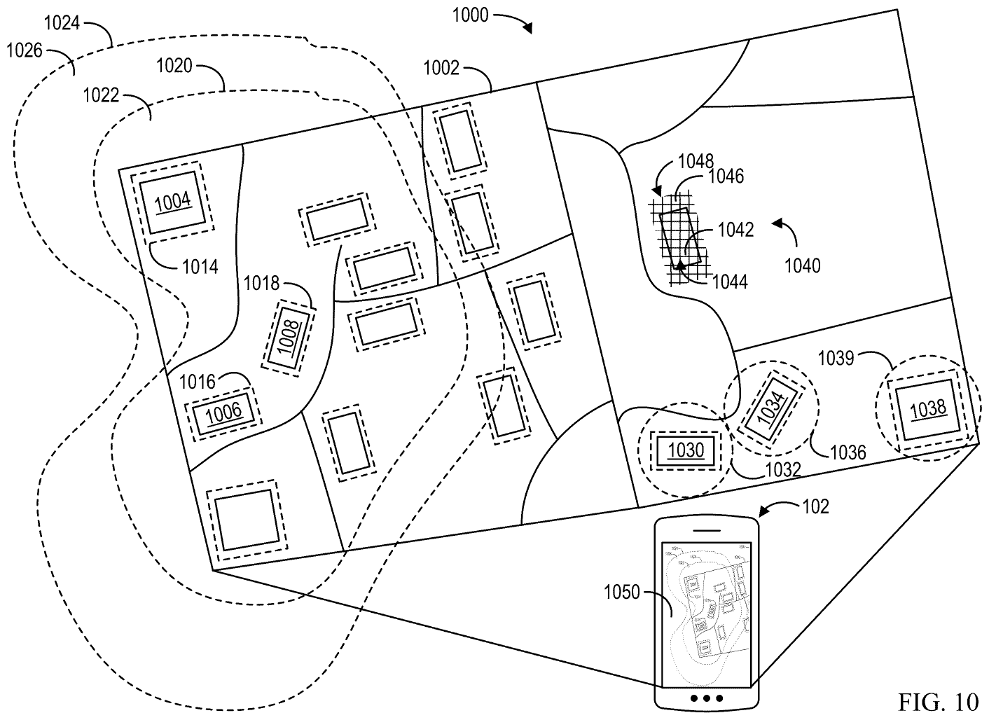

FIG. 10 an example map 1000 in accordance with one or more implementations of the present disclosure is shown. The map 1000 may be displayed as an image 1050 on user device 102. The map 1000 may include roads 1002 or other landmarks. For example, the map 1000 may depict a subdivision with roads 1002, as shown. The map 1000 may include details (e.g., natural foliage, landscaping, architectural information, etc.) of the depicted region or be generated at a higher level of abstraction. The map 1000 may be a satellite image of a region or a rendering of the region. The map 1000 may be rendered by a computer or hand drawn.

The roads 1002 may provide access to buildings. For example, the buildings may include homes 1006, 1008, 1030, 1034, 1040. The buildings may also include commercial or industrial buildings 1004, 1038 or complexes. The map 1000 depicts boundaries 1014, 1016, 1018, 1020, 1024, 1032, 1036, 1039. Boundaries may be different shapes, sizes, and arrangements. For example, boundaries 1014, 1016, 1018, may be based on a neural network or another machine learning architecture. The boundaries 1014, 1016, 1018 may be associated with buildings (e.g., buildings 1004, 1006, 1008). For example, the boundaries 1014, 1016, 1018 may be recognized through a trained neural network. For example, the neural network may be trained to segment training images (e.g., images similar to image 1050). Pixels (e.g., pixels 1042, 1046) of the training images may be identified as an inside pixel (e.g., pixel 1042) or an outside pixel (e.g., pixel 1046) of buildings (e.g., buildings 1004, 1006, 1008, 1040). As such, the training images may be segmented to identify segments of the image related to the inside of the building (e.g., inside segment 1044) and outside of the building (e.g., outside segment 1048). As such, boundaries between the segments may be recognized as buildings and may be indicated as boundaries (e.g., boundaries 1014, 1016, 1018).

Boundaries may be defined by input on the user device 102 and/or another device. For example, boundary 1024 may be drawn, sketched, or otherwise disposed on image 1050. For example, the boundary 1024 may be associated with an address of a user of the user device 102 (e.g., home 1008). The boundary 1024 may be freeform or drawn based on predetermined geometric shapes. The boundary 1024 may have an area 1026. A value of the area 1026 (e.g., quantity of pixels) may be determined based on pixel counting of pixels enclosed or indicated by the boundary 1024. A value of the area 1026 may be converted, based on a scale of the image 1050. The scale may be related to GPS coordinates associated with the image 1050 indicative of a real-world scale of the drawing (e.g., square meters, square feet, or the like). The value of the area 1026 may be rounded for case of use. An operator of networks 210, 240 may limit the area bounded by the boundary 1024. For example, the boundary 1024 may be limited to 500 square meters. After receiving the boundary 1024, the user device 102 or another device may enlarge or shrink the boundary to the required area while the same shape is maintained. For example, a centroid of boundary 1024 may be determined on image 1050. The boundary 1020 (e.g., perimeter) may have the same centroid, and the user device 102 or another device may reduce the size of boundary 1024 with respect to the centroid until the value of area 1026 satisfies the threshold value of area 1022. For example, the boundary 1024 may be radially reduced toward the centroid until the value of area 1026 is less than or equal to the value of area 1022.

Boundaries may be based on an address, a geolocation (e.g., GPS coordinates), or a combination thereof. For example, an address (e.g., post office address) may be received by the user device 102 or another device. A device (e.g., user device 102 or a device of one of the networks 210, 240) may convert the address into GPS coordinates. Based on the GPS coordinates, a geometric shape may be centered or have a centroid located at the GPS coordinates on map 1000 or image 1050. For example, the boundaries 1032, 1036, 1039 relate to buildings 1030, 1034, 1038 and addresses associated therewith. The boundaries 1032, 1036, 1039 may be a geometric shape. For example, the boundaries 1032, 1036, 1039 may be circles defined by a radius having an origin at the address or geolocation of the buildings 1030, 1034, 1038. The origin of the boundaries 1032, 1036, 1039 may be based on geolocation or coordinates received from the user device 102 or another device.

The boundaries 1014, 1016, 1018, identified by segmentation or other boundaries may be selected on the user device 102 as the boundaries of one or more of the rules 802, as discussed herein. For example, the selection may be sent to one or more of networks 210, 240. The selection may be stored in a policy control function. The selection may also be stored on the user device 102. The selection or other applicable boundaries may be assigned an identifier. The identifier may be unique to the user (e.g., the user device 102) or unique to the system (e.g., network 210, 240) that the boundary is associated with. One or more of the rules 802 may be indicative of or include the identifier. For example, the identifier may be sent with the rule (e.g., “Traffic Descriptor: UDP, DestAddr 1.2.3.4”, “Steering Mode: Active-Standby, Active=3GPP, Standby=non3GPP, boundary=”d131dd02c5c6ccc4″). The boundary, or selected boundaries, may be sent along with or in one or more of the rules 802. For example, the boundary may be sent as set (e.g., list, dictionary, etc.) of coordinates (e.g., GPS coordinates) defining the boundary. That is, the selected pixels of the boundary may be converted to GPS coordinates through a lookup table or another processes (e.g., interpolation, extrapolation, and/or the like). The GPS coordinates may be compressed or reduced for more efficient transmission.

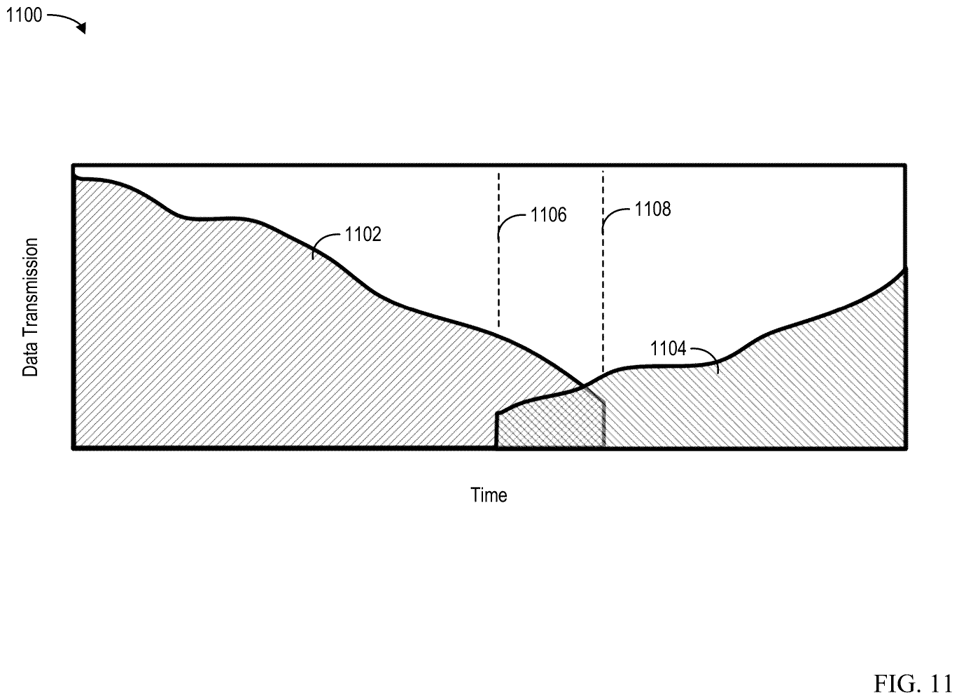

In FIG. 11, an example mode 1100 in accordance with one or more implementations of the present disclosure is shown. The mode 1100 may be identified by one or more of the rules 802 or the policy 704. For example, the mode 1100 may be a handover or active-standby mode. In combination with the techniques described herein, a multipath connection may select a path (e.g., path 540, 550) based on one or more rules 802. For example, the rules 802 may specify certain conditions where multipath data is transitioned from path 540 to path 550, and vice versa, as indicated by the quantity of data transmissions 1102, 1104 respectively. Such transitions may be enabled or otherwise based on the parameters and the boundaries as defined in the rule 802, networks 210, 240, or user device 102. For example, transitions between the paths 540, 550 may be enabled based on a parameter based on a geolocation of the user device 102 and one or more boundaries (e.g., boundaries 1014, 1016, 1018, 1020, 1024, 1032, 1036, 1039) or another indication that the transition is enabled. Paths 540, 550 may be established or configured and disassembled based on one or more rules 802 as well, as shown at time 1106 and time 1108.

The mode 1100 may comprise steering modes determining how one or more data flows are distributed across 3GPP (e.g., network 210) and non-3GPP accesses (e.g., network 240). The steering modes may comprise an active-standby mode, a smallest delay mode, a load-balancing mode, a priority-based mode, and/or a redundant mode as describe above. In FIG. 11, the steering mode received in the rule (e.g., ATSSS rule) may be an active-standby mode. The rule or mode 1100 may also include an identifier indicating the geolocation (e.g., GPS, boundary, direction, and speed) set for the user device 102. The data transmission 1102 may be WiFi traffics using the network 550 (i.e., non-3GPP radio access technology (RAT)). The data transmission 1102 may also be an active traffic (i.e., Active=non-3GPP). The data transmission 1104 may be cellular traffics (e.g., 4G or 5G) using the network 540 (i.e., 3GPP RAT). The data transmission 1104 may also be a standby traffic (i.e., Standby=3GPP).

At time 1106, the user device 102 may recognize the data transmission 1102 is getting decreased (e.g., the rate of transmission is reduced) around time 1106 and determine, based on the mode, to handover the data traffic from the non-3GPP network 550 to the 3GPP network 540. For example, the user device 102 may determine the handover based on that the data transmission rate does not satisfy a threshold (e.g., goes below the threshold). Additionally or alternatively, the user device 102 may determine the handover based on the geolocation of the user device 102. For example, the user device 102 may compare the current geolocation of the user device 102 and the identifier indicating the geolocation received in the rule. Specifically, the user device 102 may determine that the user device 102 is located outside of the boundary or GPS coordinate based on the identifier in the rule. Additionally or alternatively, the user device 102 may determine the handover based on the vector of direction associated with the user device 102. The vector of direction may comprise the direction of the user device's moving, the speed of the user device's moving, the angle of the user device's moving, or the like. The user device may anticipate, based on the vector of direction, that the user device 102 will go outside of the boundary or geolocation indicated by the identifier or by the rule. Additionally or alternatively, the user device 102 may determine the handover based on received signal level or strength (e.g., RSRP, RSSI, and the like) of the user device 102. For example, as the user device 102 approaches toward the outside of the boundary or geolocation, the user device 102 may experience reduced signal strength from the base station, AP, or gateway. The user device 102 may consider this reduced signal strength with the geolocation of the user device 102 or the boundary to determine the handover.

At time 1106, the user device 102 may initiate, based on the rule or the mode, the data transmission 1104 for the handover. For example, the data transmission 1104 has been in standby status and the user device 102 may start sending data transmission 1104 using the 3GPP RAT, such as cellular modem or mobile chipset. Between time 1106 and time 1108, the user device 102 may send both data transmissions 1102, 1104 for seamless connection of the two flows 1102, 1104. At time 1108, the user device 102 may close the data transmission 1102 and handover the traffic flow to the 3GPP network 540.

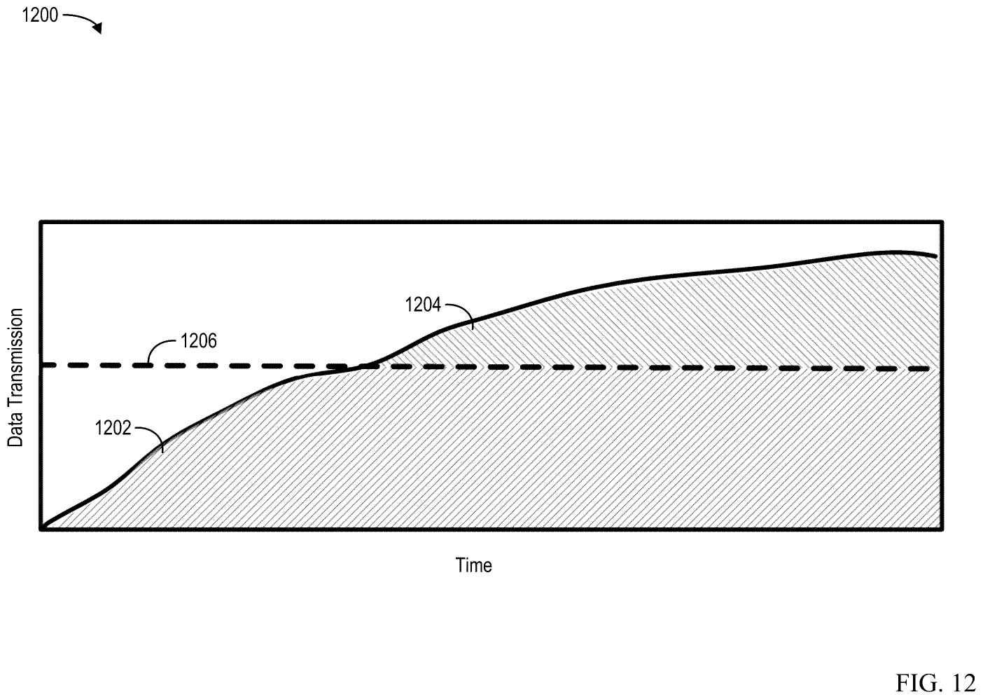

In FIG. 12, an example mode 1200 in accordance with one or more implementations of the present disclosure is shown. The mode 1200 may be identified by one or more of the rules 802 or the policy 704. For example, the mode 1200 may be an overflow or priority-based mode. In combination with the techniques described herein, a multipath connection may select a path (e.g., path 540, 550) based on one or more rules 802. For example, the rules 802 may specify certain conditions where the multipath data overflows from one of the paths (e.g., path 540 or path 550) to another of the paths. For example, the throughput 1202, or percentage thereof, on the primary path (e.g., path 540) may reach a maximum throughput (e.g., throughput 1206) by the downlink, uplink, or combination thereof associated with user device 102. After reaching the maximum the throughput 1206 on the path (e.g., path 540), overflow data traffic (e.g., traffic over a predetermined threshold 1204) may traverse another path (e.g., path 550) instead of path 540. Such transitions may be enabled or otherwise based on the parameters and the boundaries as defined in the rule 802, networks 210, 240, or user device 102. For example, transitions between the paths 540, 550 may be enabled based on a parameter based on a geolocation of the user device and one or more boundaries (e.g., boundaries 1014, 1016, 1018, 1020, 1024, 1032, 1036, 1039) or another indication that the transition is enabled.

The mode 1200 may comprise steering modes determining how one or more data flows are distributed across 3GPP (e.g., network 210) and non-3GPP accesses (e.g., network 240). The steering modes may comprise an active-standby mode, a smallest delay mode, a load-balancing mode, a priority-based mode, and/or a redundant mode as describe above. In FIG. 12, the steering mode received in the rule (e.g., ATSSS rule) may be a priority-based mode. The rule or mode 1100 may also include an identifier indicating the geolocation (e.g., GPS, boundary, direction, and speed) set for the user device 102. The data transmission 1202 may be WiFi traffics using the network 550 (i.e., non-3GPP RAT). The data transmission 1202 may also be a high priority access traffic. The data transmission 1204 may be cellular traffics (e.g., 4G or 5G) using the network 540 (i.e., 3GPP RAT). The data transmission 1204 may also be a low priority access traffic.

As illustrated in FIG. 12, the user device 102 may maintain the two data transmissions 1202, 1204 simultaneously prioritizing the WiFi traffic (i.e., data transmission 1202) and adding the cellular traffic (i.e., data transmission 1204) when WiFi traffic is congested. The user device 102 may determine these two flows 1202, 1204 based on the steering mode (i.e., a priority-based mode) and the identifier indicating the geolocation (e.g., GPS, boundary, direction, and speed) set for the user device 102. For example, when the data transmission 1202 is congested, the user device 102 may determine to add the data transmission 1204 by comparing the current geolocation of the user device 102 with the identifier indicating the geolocation set for the user device 102. The user device 102 may be located in an area closer to the 3GPP network 540 but relatively farther away from the non-3GPP network 550.

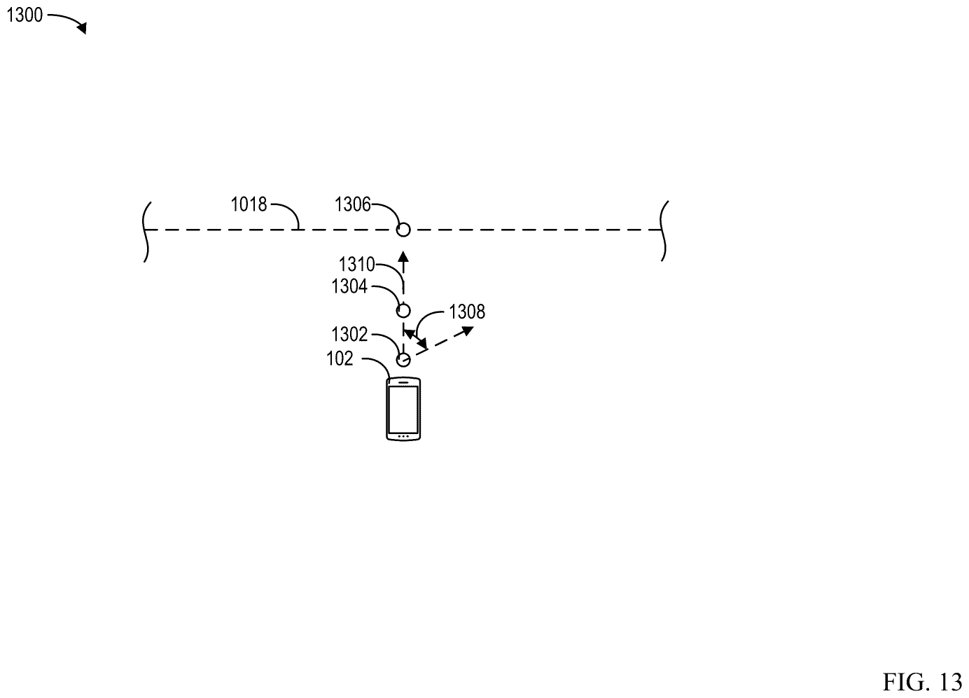

In FIG. 13, an example illustration 1300 associated with enabling a mode (e.g., mode 1100, mode 1200) in accordance with one or more implementations of the present disclosure are shown. For example, the user device 102 may be associated with a first coordinate 1302. The coordinate may be a GPS coordinate or another coordinate. A second coordinate 1304 may be further associated with the user device 102 at a different time. The coordinates 1302, 1304 may be used by the user device 102 or another device to establish a vector 1310. The vector 1310 may include a speed (e.g., five feet per second). The vector 1310 may further include a direction 1308 (e.g., heading 125° from North). An intercept 1306 with a boundary (e.g., boundary 1018) may be determined. For example, the vector 1310 may be used to predict when a boundary (e.g., boundary 1018) may be intercepted or traversed. An expected traversal of the boundary (e.g., boundary 1018) may notify the user device 102 or another device to request that an additional and/or alternative path (e.g., path 540, path 550) be established for data transmission in accordance with one or more rules 802. For example, a path (e.g., path 540) may be disassemble based on a prediction or estimation that the user device 102 is going to enter or leave a boundary (e.g., boundary 1018). A predictive analysis may be performed to determine a likelihood that the user device 102 will intersect the boundary (e.g., boundary 1018). For example, if the likelihood satisfies a likelihood threshold, the user device 102 may establish or disassemble one or more paths (e.g., paths 540, 550). The likelihood of intersection may be further based on the speed or direction 1308. For example, a neural network or another machine learning algorithm may be used to determine whether the user device 102 is possessed by a user that is walking or riding in a car. These determinations may be used to determine the likelihood of intersection. As described above, the user device 102 may also determine, one or more paths or networks (e.g., 3GPP or non-3GPP) for one or more data traffics, data flows, or data transmissions based on the rule (e.g., steering mode) and based on the vector associated with the user device 102.

The likelihood of intersection may be represented as a confidence factor. The confidence factor may be determined based on a neural network or another machine learning algorithm. The likelihood may be determined based on the confidence factor satisfying a threshold or categorized by the neural network or another machine learning algorithm. For example, the neural network may be trained on example data of the parameter where the user device intersected the boundary 1018 and example data of the parameter where the user device did not intersect the boundary 1018.

The parameter (e.g., speed) may be used to determine the likelihood of intersection. For example, if the speed satisfies a threshold (e.g., greater than five feet per second) or if an aggregate speed satisfies a threshold (e.g., greater than five feet per second on average for five minutes), an intersection with the boundary is likely to occur and the mode should be enabled. If the speed does not satisfy the threshold (e.g., less than five feet per second) or if the aggregate speed does not satisfy the threshold (e.g., less than five feet per second on average for five minutes), an intersection with the boundary is not likely to occur and the mode should not be enabled, or vice versa. For example, the satisfaction of the threshold may be based on the distance the parameter is from the threshold or a rate of change in relation to the threshold. For example, if the parameter satisfies a secondary threshold (e.g., speed is greater than 20 feet per second, or average speed) then the likelihood of intersection may be increased. The converse is also contemplated (e.g., speed less than a secondary threshold of one foot per second).

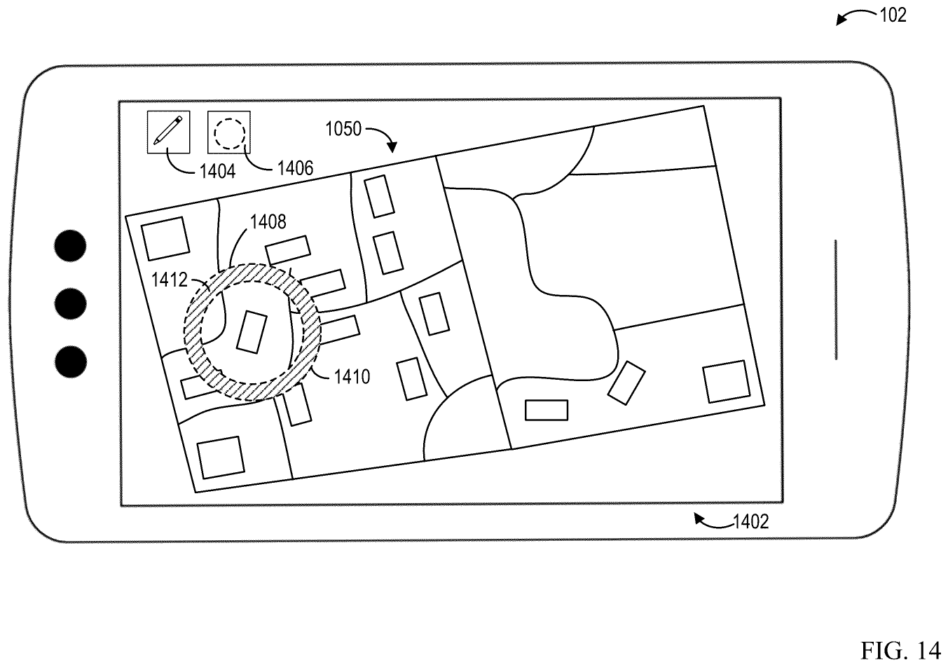

In FIG. 14, an example interface 1402 in accordance with one or more implementations of the present disclosure. The interface 1402 may be part of user device 102. The interface 1402 may be available on a web application or other front end device. For example, the interface may be on a computer or other device located at a store for issuing subscriptions or purchasing user devices 102. The interface 1402 may be configured to receive user input through a capacitive touch screen or a mouse based screen. The interface 1402 may include tools 1404, 1406 for drawing or indicating boundaries. The interface 1402 may also include a selection tool (not shown) for selecting drawn boundaries (e.g., boundary 1408). The interface 1402 is configured to allow boundaries (e.g., boundary 1408) to be shaded or matched. For example, boundary 1408 may bound an area 1412 in combination with another boundary (e.g., boundary 1410). As such, a band around home (e.g., 1408) may be indicated to enable overflow or active-standby modes (e.g., mode 1100, mode 1200) within (or out of) the area 1412.

The user device 102 may configure (or override) the mode (e.g., steering mode) received in the rule (e.g., ATSSS rule) based on the user's input on the interface 1402. For example, the user may designate a certain boundary (e.g., 1408) on the interface 1402 for a specific mode. The user may configure the user device 102 via the interface 1402 that the designated boundary (e.g., 1408) is a home and the mode is set to the overflow mode, the priority-based mode, or the load-balancing mode to use the benefit of multiple traffic flows (e.g., 3GPP and non-3GPP traffics). The user may configure the user device 102 via the interface 1402 that the designated boundary (e.g., outside of 1408) is not a home and the mode is set to the handover mode or the active-standby mode to obtain seamless access between a home network (e.g., WiFi) and a cellular network (e.g., 4G, 5G). The user may configure multiple locations or multiple boundaries for one or more modes.

In addition, the user device 102 may configure the mode based on the application running on the user device 102 or application data running on the user device 102. For example, although the user device 102 received the handover mode or the active-standby mode as the steering mode from the network, the user device 102 may override the steering mode to the overflow mode or the load-balancing mode when the application running in the user device is, for example, Netflix. By reconfiguring or overriding the initial steering mode, the user device 102 may obtain the benefit of multiple paths for streaming video data. In another example, although the user device 102 received the overflow mode or the load-balancing mode as the steering mode from the network, the user device 102 may override the steering mode to the handover mode or the active-standby mode based on the application data running in the user device 102. For example, the user device 102 may run an application (e.g., Netflix), but the application may not download the streaming data (i.e., the user is not watching a movie). In this situation, the user device 102 may not need the benefit of additional traffic flow (e.g., 3GPP traffic or non-3GPP traffic).

The network (e.g., base station or AP) may interactively configure the mode (e.g., steering mode) based on the user device's location. For example, when the user initiate the subscription of the user device 102 for the first time, the network may request the user for one or more geolocations or boundaries that the user will use the user device 102 via the interface 1402. The user may select one or more modes for the selected gcolocations or boundaries. The network may request the user device 102 to configure the mode (e.g., steering mode) based on the user's preference. For example, the network may cause the user device 102 to display a message whether the user wants to change the mode in a certain location or boundaries.

The network may dynamically configure the modes based on the user device's 102 location. For example, when the user device 102 is located in a heavy traffic area (e.g., downtown), the network may provision the rule or policy with the steering mode of the load-balancing mode or the priority-based mode to offload the heavy traffics. when the user device 102 is located in a less traffic area (e.g., suburb), the network may provision the rule or policy with the steering mode of the active-standby for seamless connection of network traffics. The network may dynamically configure the modes based on time of day. For example, when the user device 102 is in a heavy traffic hours, the network may provision the rule or policy with the steering mode of the load-balancing mode or the priority-based mode to offload the heavy traffics.

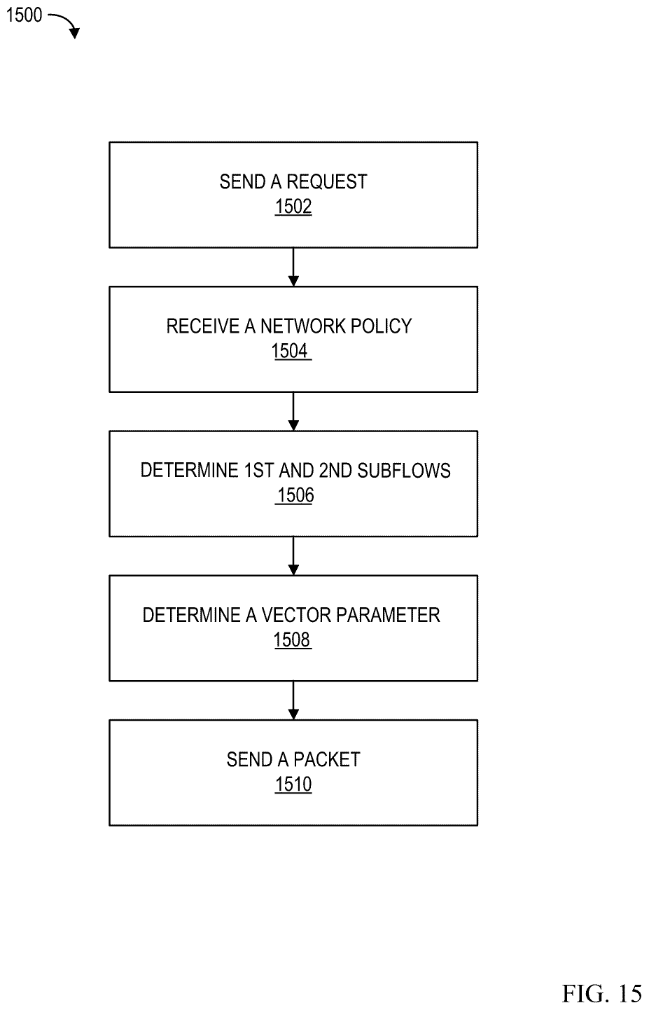

In FIG. 15, an example method 1500 in accordance with one or more implementations of the present disclosure is shown. The method 1500 may be performed by any of the devices or nodes discussed herein and combinations thereof. For example, the method 1500 may be performed by the user device 102, the application server 270, the computing device 122, other nodes, and combinations thereof. In step 1502, a request may be sent. The request may be to connect a user device (e.g., user device 102) or another device to a network (e.g., network 210, 240). In step 1504, a network policy (e.g., policy 704) may be received at the requesting device (e.g., user device 102). The policy 704 may be an ATSSS policy or ATSSS rules as discussed herein. The policy 704 may comprise a rule (e.g., rule 802). The rule may be based on positive or negative logic. For example, the rule may be related to a connection. The connection may be a multipath connection or portion thereof. For example, the rule may specify when a multipath connection may be allowed or denied. The policy may specify when data of the connection is steered between networks 210, 240, for example, a 3GPP network such as 4G, 5G network and a non-3GPP network such as WiFi. For example, the rule may be one or more of rules 802. The rule may specify a parameter. A parameter may be data available to the user device 102 or the network 210, 240. The parameter may be associated with a geolocation of the user device 102. The rule may be indicative of a mode determining traffic flow or access to networks 210, 240.

In step 1506, a first subflow (e.g., subflow 510) may be determined. The first subflow may be based on the connection. The subflow may be based on the rule. For example, the first subflow may be allowed because the rule allows the subflow to be formed. The first subflow may be based on a first path. For example, the first path may include one or more nodes of networks 210, 240. Data may be sent/received based on the first subflow.

A second subflow (e.g., subflow 520) may be determined forming a multipath connection with the user device 102. For example, the second subflow may have its own identifier and may be configured to receive data. Data received over the second subflow may be combined with data from the first subflow and sent to an application server (e.g., application server 270). Similarly, data received from the application server may be divided over the subflows and sent to the user device 102. Data sent to the application server based on data received from the subflows may be formed into one or more data packets.

In step 1508, a vector parameter indicating the mobility of the user device 102 may be determined. For example, the user device 102 may determine the vector parameter based on the directional movement of the user device 102. The directional movement of the user device 102 may include, but are not limited to, a speed (e.g., five feet per second), a direction of the movement, and an angle of the movement.

In step 1510, packets or data may be sent or received to or from the user device 102. For example, the user device 102 may send a packet based on the rule. The user device 102 may also send the packet based on the parameter associated with the geolocation of the user device 102 and the vector parameter indicative of the mobility of the user device 102. The packet may be sent on a path (e.g., path 540) based on a subflow (e.g., subflow 510) according to the rule or depending on which mode is enabled. One of the networks 210, 240 may also send a packet on a path (e.g., path 540) based on a subflow (e.g., subflow 510) according to the rule or depending on which mode is enabled. The packet may be sent, based on the mode, the parameter, and the vector parameter on a path 540 implementing a 3GPP network. The packet may be sent, based on the mode, the parameter, and the vector parameter on a path 550 implementing a non-3GPP network. For example, when the steering mode is the active-standby mode (e.g., active for non-3GPP network and standby for 3GPP network) and the vector parameter indicate that the directional movement of the user device 102 is toward the 3GPP network, the user device 102 may start sending the packet using the 3GPP network (i.e., standby) instead of using the non-3GPP network (i.e., active). The user device 102 may also use the parameter associated with the geolocation of the user device 102 and the vector parameter to determine the path.

The policy or rule may be pre-provisioned. For example, the policy or rule may store on the user device 102 before a connection is attempted to either of the networks 210, 240. Policies may be defined based on identifiers of the user device 102 or other parameters. For example, the policies may be defined based on a service agreement and be individual to a user device 102 or a group of user devices. The policy may be sent from one or more of networks 210, 240.

The mode may be related to an indication of congestion of one or more of the paths or subflows. The congestion may be related to throughput (e.g., throughput 1206). For example, as data on one of the paths (e.g., path 540) or one of the subflows (e.g., subflow 510) reaches the available or allotted throughput for the path, the mode may be enabled based on the parameter and the boundary to allow overflow traffic to use the second path. For example, the network 210 may track the throughput (e.g., the quantity of data sent, received, or combination thereof over a predetermined interval). Once data over the quantity of time reaches the threshold, or portion thereof, the over flow packets may be sent on a different path (e.g., path 550). For example, an indication may be sent to the user device 102 or networks 210, 240 indicating the contemporaneous throughput over the path. The indication may further require that any future streams or packets are sent over a different path.

The policy (e.g., policy 704) may comprise more than one of the rules 802. For example, a second rule may be indicative of a second mode that may be enabled. The second mode can similarly direct data or packets between the paths 540, 550 according to an active or standby status. One or more the rules 802 may take precedence over the other. For example, when both modes are enabled (e.g., based on the parameter), one of the modes may be indicated by rules as taking priority over the other rules, and each of the rules 802 may have boundaries that are unique. For example, one rule may include a first boundary and another rule may include the first boundary and a second boundary. One rule may include a first boundary and another rule may include a second boundary.

Enablement of the modes may be based on the parameter and one or more of the boundaries (e.g., boundaries 1014, 1016, 1018, 1020, 1024, 1032, 1036, 1039). For example, the method 1500 may further comprise determining whether the parameter (e.g., coordinates) are within one or more of the boundaries 1014, 1016, 1018, 1020, 1024, 1032, 1036, 1039 to determine whether the mode is enabled. The boundaries may be provided with the policy. For example, the boundaries 1014, 1016, 1018, 1020, 1024, 1032, 1036, 1039 may be sent to the user device 102 in a set of coordinates that define the boundary or a derivative of the boundary indicative of the original boundary. The boundaries 1014, 1016, 1018, 1020, 1024, 1032, 1036, 1039 may further be installed on the user device 102 or available to the user device 102 at purchase or activation. For example, a user of the user device 102 may define the boundaries 1014, 1016, 1018, 1020, 1024, 1032, 1036, 1039 at purchase or activation and the boundaries may be stored on the user device or a derivative of the boundary indicative of the original boundary. The policy 704 or user device 102 may further include an identifier of the boundary or set of boundaries for one or more of the rules or modes.

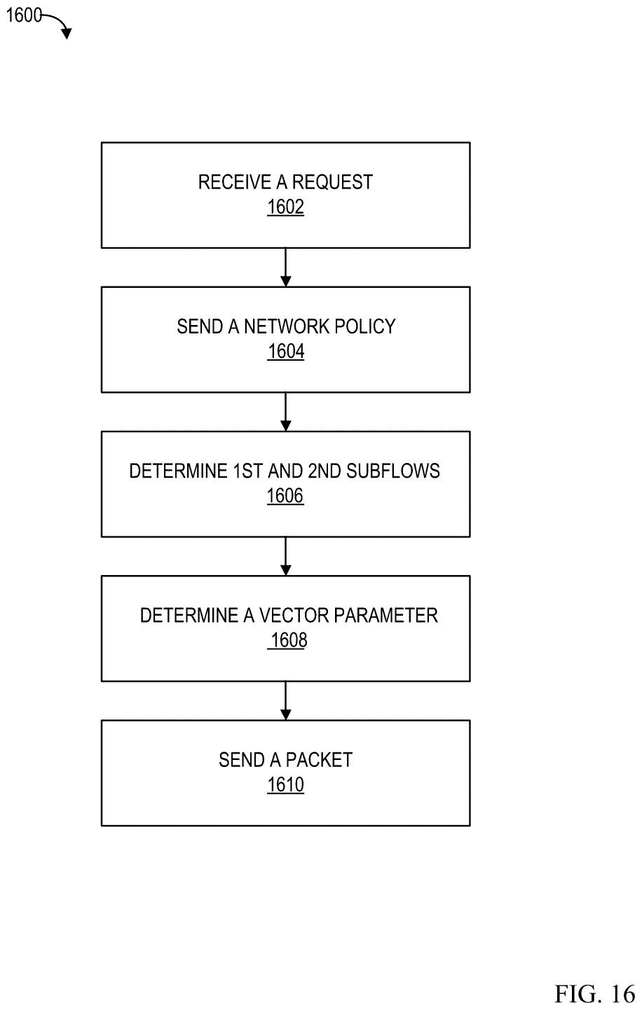

In FIG. 16, an example method 1600 in accordance with one or more implementations of the present disclosure is shown. The method 1600 may be performed by any of the devices or nodes discussed herein and combinations thereof. For example, the method 1600 may be performed by the user device 102, the application server 270. the computing device 122, other nodes, and combinations thereof. In step 1602, a request may be received. The request may be to connect a user device (e.g., user device 102) or another device to a network (e.g., network 210, 240). In step 1604, a policy 704 may be sent to the requesting device (e.g., user device 102). The policy 704 may be an ATSSS policy or ATSSS rules as discussed herein. The policy 704 may comprise a rule (e.g., one of rules 802). The rule may be based on positive or negative logic. For example, the rule may be related to a connection. The connection may be a multipath connection or portion thereof. For example, the rule may be one or more of rules 802. The rule may specify a parameter. A parameter may be data available to the user device 102 or the network 210, 240. The parameter may be associated with a geolocation of the user device 102. The rule may be indicative of a mode determining traffic flow or access to networks 210, 240.

In step 1606, a first subflow (e.g., subflow 510) may be determined. The subflow may be based on the connection. The first subflow may be based on the rule. For example, the subflow may be allowed because the rule allows the subflow to be formed. The subflow may be based on a path. For example, the path may include one or more nodes of networks 210, 240. Data may be received based on the subflow.

A second subflow (e.g., subflow 520) may be determined forming a multipath connection with the user device 102. For example, the second subflow may have its own identifier and may be configured to receive data. Data received over the second subflow may be combined with data from the first subflow and sent to an application server (e.g., application server 270). Similarly, data received from the application server may be divided over the subflows and sent to the user device 102. Data sent to the application server based on data received from the subflows may be formed into one or more data packets.

In step 1608, a vector parameter indicating the mobility of the user device 102 may be determined. For example, an application server 270, the transport converter 290, or a computing device 122 may receive information of the user device's directional movement from the user device 102. The application server 270, the transport converter 290, or the computing device 122 may determine the vector parameter based on the information of the user device's directional movement. The directional movement of the user device 102 may include, but are not limited to, a speed (e.g., five feet per second), a direction of the movement, and an angle of the movement. In another example, the application server 270, the transport converter 290, or the computing device 122 may receive the vector parameter from the user device 102.

In step 1610, packets or data may be sent or received to or from the user device 102. For example, The application server 270, the transport converter 290, or a computing device 122 may send a packet based on the rule. The application server 270, the transport converter 290, or a computing device 122 may also send the packet based on the parameter associated with the geolocation of the user device 102 and the vector parameter indicative of the mobility of the user device 102. The packet may be sent on a path (e.g., path 540) based on a subflow (e.g., subflow 510) according to the rule or depending on which mode is enabled. One of the networks 210, 240 may also send a packet on a path (e.g., path 540) based on a subflow (e.g., subflow 510) according to the rule or depending on which mode is enabled. The packet may be sent, based on the mode, the parameter, and the vector parameter on a path 540 implementing a 3GPP network. The packet may be sent, based on the mode, the parameter, and the vector parameter on a path 550 implementing a non-3GPP network. For example, when the steering mode is the active-standby mode (e.g., active for non-3GPP network and standby for 3GPP network) and the vector parameter indicate that the directional movement of the user device 102 is toward the 3GPP network. The application server 270, the transport converter 290, or a computing device 122 may start sending the packet using the 3GPP network (i.e., standby) instead of using the non-3GPP network (i.e., active). The application server 270, the transport converter 290, or a computing device 122 may also use the parameter associated with the geolocation of the user device 102 and the vector parameter to determine the path.

The policy or rule may be pre-provisioned. For example, the policy or rule may store on or be accessible to the transport converter 290 before a connection is attempted to either of the networks 210, 240. Policies may be defined based on identifiers of the user device or other parameters. For example, the policies may be defined based on a service agreement and be individual to a user device 102 or a group of user devices. The policy may be sent from one or more of networks 210, 240.

The mode may be related to an indication of congestion of one or more of the paths or subflows. The congestion may be related to throughput 1206. For example, as data on one of the paths (e.g., path 540) or one of the subflows (e.g., subflow 510) reaches the available or allotted throughput for the path, the mode may be enabled based on the parameter and the boundary to allow overflow traffic to use the second path. For example, the network 210 may track the throughput (e.g., the quantity of data sent, received, or combination thereof over a predetermined interval). Once data over the quantity of time reaches the threshold, or portion thereof, the over flow packets may be sent on a different path (e.g., path 550). For example, an indication may be sent to the transport converter 290 or another network component indicating the contemporaneous throughput over the path. The indication may further require that any future streams or packets are sent over a different path.

The policy (e.g., policy 704) may comprise more than one of the rules 802. For example, a second rule may be indicative of a second mode that may be enabled. The second mode can similarly direct data or packets between the paths 540, 550 according to an active or standby status. One or more the rules 802 may take precedence over the other. For example, when both modes are enabled (e.g., based on the parameter), one of the modes may be indicated by rules as taking priority over the other rules, and each of the rules 802 may have boundaries (e.g., one or more of boundaries 1014, 1016, 1018, 1020, 1024, 1032, 1036, 1039) that are unique. For example, one rule may include a first boundary and another rule may include the first boundary and a second boundary. One rule may include a first boundary and another rule may include a second boundary.

Enablement of the modes may be based on the parameter and one or more of the boundaries (e.g., boundaries 1014, 1016, 1018, 1020, 1024, 1032, 1036, 1039). For example, the method 1600 may further comprise determining whether the parameter (e.g., coordinates) are within one or more of the boundaries 1014, 1016, 1018, 1020, 1024, 1032, 1036, 1039 to determine whether the mode is enabled. The boundaries may be provided with the policy. For example, the boundaries 1014, 1016, 1018, 1020, 1024, 1032, 1036, 1039 may be sent to the user device 102 in a set of coordinates that define the boundary or a derivative of the boundary indicative of the original boundary. The boundaries 1014, 1016, 1018, 1020, 1024, 1032, 1036, 1039 may further be installed on the user device 102 or available to the user device 102 at purchase or activation. For example, a user of the user device 102 may define the boundaries 1014, 1016, 1018, 1020, 1024, 1032, 1036, 1039 at purchase or activation and the boundaries may be stored on the user device or a derivative of the boundary indicative of the original boundary. The policy 704 or user device 102 may further include an identifier of the boundary or set of boundaries for one or more of the rules or modes.

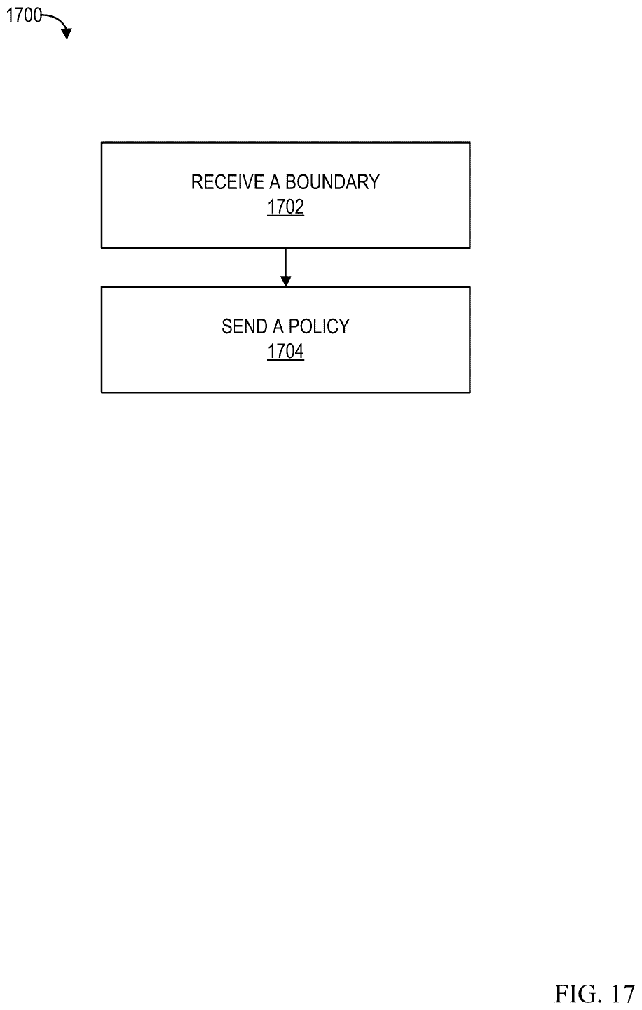

In FIG. 17, an example method 1700 in accordance with one or more implementations of the present disclosure is shown. The method 1700 may be performed by any of the devices or nodes discussed herein and combinations thereof. For example, the method 1700 may be performed by the user device 102, the application server 270, the computing device 122, other nodes, and combinations thereof.

In step 1702, a boundary (e.g., one or more of boundaries 1014, 1016, 1018, 1020, 1024, 1032, 1036, 1039) may be received. For example, the user device 102, the application server 270, the computing device 122, other nodes, and combinations thereof may receive the boundary. The boundary may be defined by a user of user device 102. For example, during purchase or activation of the user device 102 on network 210 or network 240, the boundary may be stored on one or more of the networks 210, 240 or on the user device 102. For example, the boundary may be stored on the user device 102 with a unique identifier or a pseudo-unique identifier (e.g., unique to the associated network) of the boundary. The policy 704 may include the identifier to indicate which boundary is to be used with the policy 704 and rules 802. The boundary may be stored on one or more of networks 210, 240 and the unique identifier or pseudo-unique identifier may be stored on the user device 102. For example, when the user device 102 initiates a connection to network 210 or 240 the unique identifier may be sent to the network to indicate which boundary is to be used in conjunction with the rules. The identifier may be based on the SIM or stored in the SIM. The boundary may be define according to interface 1402 or another interface.

The boundary may be updated on the user device 102 after activation of the user device 102 on the network. For example, the user device 102 may include interface 1402 to allow a user of the user device 102 or another input to define the boundary. For example, the user device 102 may include interface 1402 to allow one or more boundaries to be drawn on an image (e.g., image 1050) associated with a map (e.g., map 1000). The user device 102 may navigate to a region of interest associated with the user to allow the user to draw or the user device 102 to indicate where boundaries for their subscription are to be located. For example, the boundaries may be indicated on the interface 1402 and then uploaded to the network (e.g., network 210, 240) for storage and inclusion in the policy 704.

In step 1704, a policy may be sent from the network (e.g., network 210 or network 240). For example, the policy may include a boundary (e.g., one or more of boundaries 1014, 1016, 1018, 1020, 1024, 1032, 1036, 1039) and one or more of rules 802. The one or more rules 802 may be associated with a parameter. The policy 704 may be associated with a subscription. For example, the user device 102 may provide an identifier associated with the SIM to network 210 or network 240 to indicate that the user device 102 is subscribed to services provided by the network. The policy 704 may be associated with the services authorized by the SIM and the network. For example, the policy 704 may include boundaries (e.g., boundaries 1014, 1016, 1018, 1020, 1024, 1032, 1036, 1039). The reception of the boundary may be associated with a subscription associated with the user device. The boundary may further be defined based on a SIM package. For example, network 210 or network 240 may provide a SIM package (e.g., an eSIM) for unpacking at the user device 102. The SIM package may provide the boundary or an indication of the boundary (e.g., unique identifier of the boundary). The SIM package may be received by the user device 102.

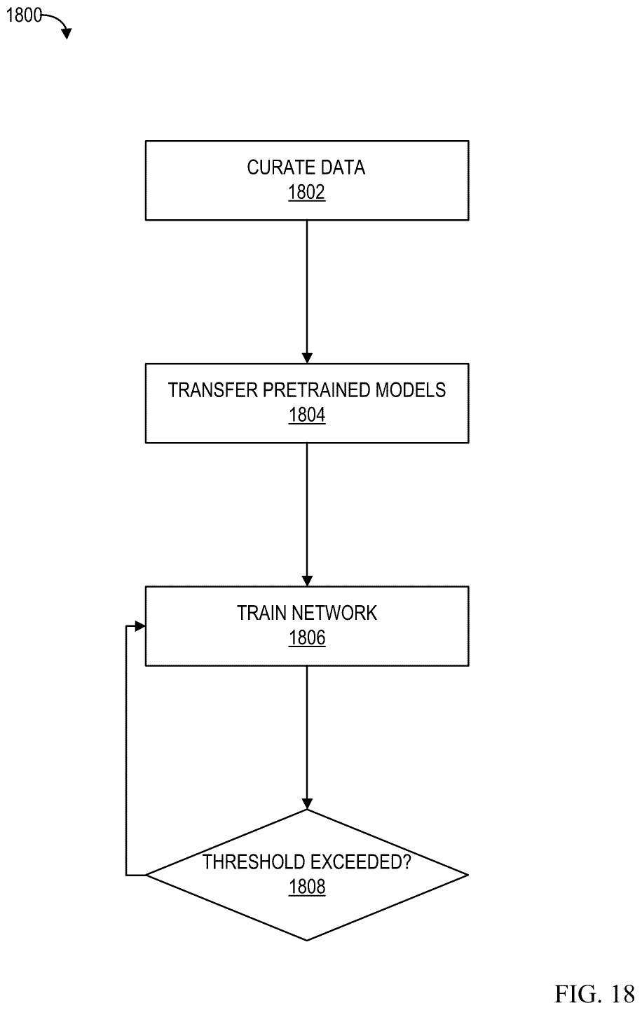

In FIG. 18, an example method 1800 for training one or more networks (e.g., a neural network, another machine learning algorithm) in accordance with one or more implementations of the present disclosure is shown. The method may be performed on one or more computing systems described herein (e.g., computing device 122, another computing device, cloud computing, and/or the like).

The method 1800 includes curation of training data and testing data in step 1802. For example, data for training the neural network may include examples of images of a map for training the neural network to label pixels as inside of homes (e.g., home 1008) or outside of homes. The data for training may include numerous images and pixel designations. The data for training may also include categories data segments where the user device 102 intersected with a boundary (e.g., boundary 1018) and data segments where the user device 102 did not intersect with the boundary. For example, the data segments may include user device parameters discussed herein (e.g., coordinates, speed, direction of travel, temperature, camera information, etc.) and other parameters to train the neural network to determine a likelihood of intersection between the user device 102 and the boundary. The neural network may be convolutional, recurrent, otherwise, or combinations thereof. The training data may be divided to reserve test data for measuring the accuracy of the determinations by the neural network.

In step 1804, the neural network may be pre-trained. For example, the neural network may be pre-trained on generic image data and transferred for additional specific learning for the task. In step 1806, the neural network, or individual neural networks (e.g., ensemble networks) may be trained according to the training data described herein until an error threshold is exceeded.

In step 1808, the neural network may be evaluated. The error may be different depending on the data trained and acceptable thresholds may be different depending on the data trained. Once the error threshold is exceeded, the neural network may be considered trained.

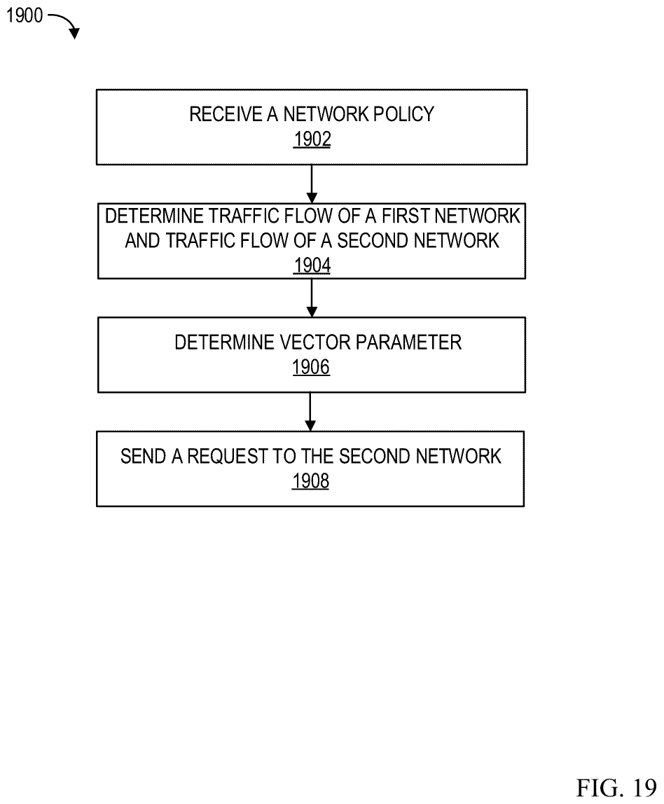

In FIG. 19, an example method 1900 in accordance with one or more implementations of the present disclosure is shown. The method 1900 may be performed by any of the devices or nodes discussed herein and combinations thereof. For example, the method 1900 may be performed by the user device 102, the application server 270, the computing device 122, other nodes, and combinations thereof.

In step 1902, a network policy may be received. For example, a user device 102 may receive a network policy associated with the geolocation of the user device 102. The network policy may be received from a PCF or a network node/server managing the network policy. The network policy may be associated with the geolocation of the user device due to the mobility of the user device 102. For example, the user device 102 may receive different network policies as the user device 102 moves from one area to another area. The network policy may include the geolocation (e.g., GPS coordinate) of the user device 102. The network policy may be received at the user device 102 via a base station or an access point depending on the radio access technology (RAT) associated with the user device 102. The network policy may include ATSSS rules. The network policy or the ATSSS rule may include one or more steering modes. The steering mode may determine how data flow may be distributed across one or more networks or RATs (e.g., 3GPP RAT and/or non-3GPP RAT). The steering mode may include an active-standby mode, a smallest delay mode, a load-balancing mode, a priority-based mode, and a redundant mode as described above. The network policy may further include an identifier indicating a boundary associated with the network policy, a network (e.g., a RAN or WiFi network) or the user device 102. The boundary may be a set of coordinates (e.g., GPS coordinates) defining an area associated with the network policy, the network, or the user device 102. The boundary may be defined by pixels of an area of an image.

In step 1904, traffic flow of a first network and traffic flow of a second network may be determined. For example, the user device 102 may determine, based on the network policy, the traffic flow of the first network and the traffic flow of the second network. Specifically, the network policy may comprise a steering mode indicating which traffic flow the user device 102 is to select under certain conditions. The steering mode may comprise an active-standby mode, a smallest delay mode, a load-balancing mode, a priority-based mode, and a redundant mode as described above. The first network may be a 3GPP network. The second network may be a non-3GPP network.

In step 1906, a vector parameter may be determined. For example, the user device 102 may determine the vector parameter indicative of the directional movement of the user device 102. The directional movement of the user device 102 may refer to a UE moving toward the first network, the second network, or a certain direction. The vector parameter may include, but are not limited to, a speed (e.g., five feet per second), a direction of the movement, and an angle of the movement. The network policy may comprise an identifier indicative of boundary associated with the user device 102. The boundary may be an area associated with the user device 102. The user device 102 may set the boundary by the user input. The vector parameter may be determined based on the geolocation of the user device and the boundary associate with the user device 102. Alternatively or additionally, the user device 102 may receive the vector parameter from the first network and/or the second network.

In step 1908, a request may be sent to the second network. For example, the user device 102 may send, based on the traffic flow of the second network and the vector parameter, a request to connect to the second network. The traffic flow of the second network may be indicated by the network policy (e.g., the steering mode). For example, when the steering mode is the active-standby mode (e.g., active for non-3GPP network and standby for 3GPP network) and the vector parameter indicate that the directional movement of the user device 102 is toward the 3GPP network, the user device 102 may initiate a handover process to transfer data transmission from the non-3GPP network to the 3GPP network. The user device 102 may also use the identifier indicative of the boundary associated with the user device 102 to determine which network the user device 102 uses to send the data transmission. For example, when the vector parameter indicates that the user device 102 enters or leaves the boundary (or close to the boundary or away from the boundary) indicated by the identifier, the user device 102 may initiate a handover process to transfer data transmission from the non-3GPP network to the 3GPP network or vice versa.

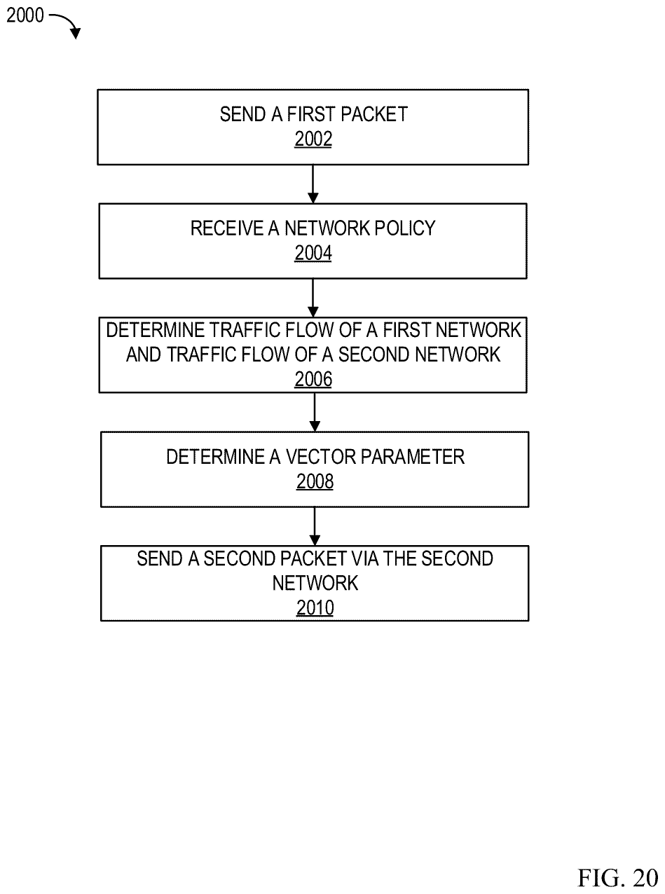

In FIG. 20, an example method 2000 in accordance with one or more implementations of the present disclosure is shown. The method 2000 may be performed by any of the devices or nodes discussed herein and combinations thereof. For example, the method 2000 may be performed by the user device 102, the application server 270, the computing device 122, other nodes, and combinations thereof.

In step 2002, a first packet may be sent. For example, a user device 102 may send a first packet using a first network. In step 2004, a network policy may be received. For example, the user device 102 may receive a network policy associated with the geolocation of the user device 102. The network policy may be sent by a PCF or a network node/server managing the network policy. The network policy may be associated with the geolocation of the user device due to the mobility of the user device 102 or include the geolocation of the user device 102. The network policy may include ATSSS rules. The network policy or the ATSSS rule may include one or more steering modes. The steering mode may determine how data flow may be distributed across one or more networks or RATs (e.g., 3GPP RAT and/or non-3GPP RAT). The steering mode may include an active-standby mode, a smallest delay mode, a load-balancing mode, a priority-based mode, and a redundant mode as described above. The network policy may further include an identifier indicating a boundary associated with the network policy, a network (e.g., a RAN or WiFi network) or the user device 102. The boundary may be a set of coordinates (e.g., GPS coordinates) defining an area associated with the network policy, the network, or the user device 102. The boundary may be defined by pixels of an area of an image.

In step 2006, traffic flow of a first network and traffic flow of a second network may be determined. For example, the user device 102 may determine, based on the network policy, the traffic flow of the first network and the traffic flow of the second network. Specifically, which traffic flow the user device 102 is to select under certain conditions may be indicted by the network policy or the steering mode in the network policy.

In step 2008, a vector parameter may be determined. For example, the user device 102 may determine the vector parameter indicative of the directional movement of the user device 102. The directional movement of the user device 102 may be toward the first network or the second network. The vector parameter may include, but are not limited to, a speed (e.g., five feet per second), a direction of the movement, and an angle of the movement. The network policy may comprise an identifier indicative of boundary associated with the user device 102. The boundary may be an area associated with the user device 102. The user device 102 may set the boundary by the user input. The vector parameter may be determined based on the geolocation of the user device and the identifier indicative of the boundary associate with the user device 102. Alternatively or additionally, the user device 102 may receive the vector parameter from the first network and/or the second network.

In step 2010, a second packet may be sent via the second network. For example, the user device 102 may send, based on the traffic flow of the second network and the vector parameter, a second packet to the second network. The first packet and the second packet may be part of the same stream. The traffic flow of the second network selected by the user device 102 may be indicated by the network policy (e.g., the steering mode).

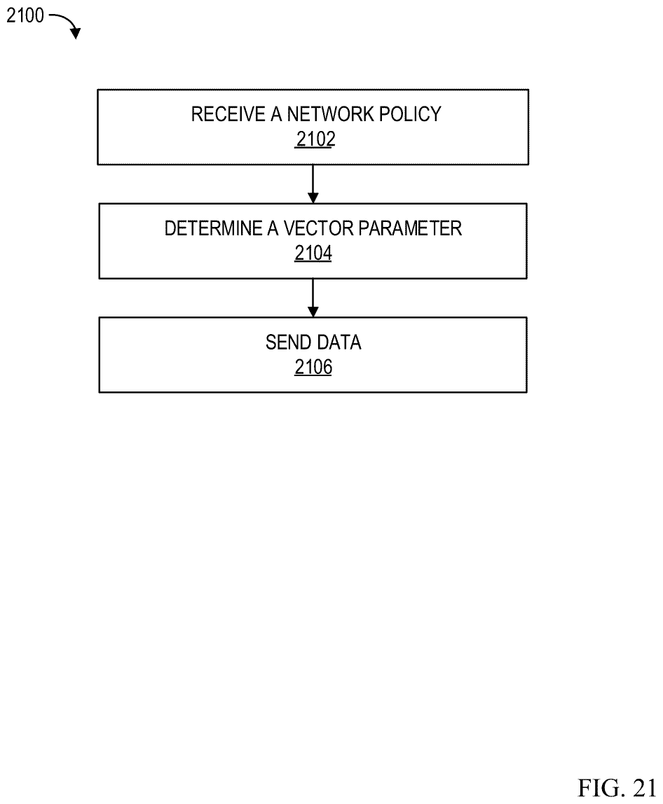

In FIG. 21, an example method 2100 in accordance with one or more implementations of the present disclosure is shown. The method 2100 may be performed by any of the devices or nodes discussed herein and combinations thereof. For example, the method 2100 may be performed by the user device 102, the application server 270, the computing device 122, other nodes, and combinations thereof.

In step 2102, a network policy may be received based on the geolocation of a user device 102. For example, the user device 102 may receive a network policy from a PCF or a network node/server managing the network policy. The network policy may be received at the user device 102 via a base station or an access point. The network polity may include ATSSS rules. The network policy or the ATSSS rule may include one or more steering modes. The steering mode may determine how data flow may be distributed across one or more network or RATs (e.g., 3GPP RAT and/or non-3GPP RAT). The steering modes may include an active-standby mode, a smallest delay mode, a load-balancing mode, a priority-based mode, and a redundant mode as described above. The network policy may further include an identifier indicating a boundary associated with the network policy or the user device 102. The boundary may be a set of coordinates (e.g., GPS coordinates) defining the boundary. The boundary may be defined by pixels of an area of an image.

In step 2104, a vector parameter may be determined. For example, the user device 102 may determine the vector parameter indicating the directional movement of the user device 102. The directional movement of the user device 102 may include, but are not limited to, a speed (e.g., five feet per second), a direction of the movement, and an angle of the movement. The directional movement of the user device 102 may be toward the first network or the second network.

In step 2006, data may be sent using at least one of the first network or the second network. For example, the user device 102 may determine, based on the steering mode and the vector parameter, which network the user device 102 uses to send the data. For example, when the steering mode is the active-standby mode (e.g., active for non-3GPP network and standby for 3GPP network) and the vector parameter indicate that the directional movement of the user device 102 is toward the 3GPP network, the user device 102 may initiate a handover process to transfer data traffics from the non-3GPP network to the 3GPP network. For example, when the steering mode is the load balancing mode and the vector parameter indicate that the directional movement of the user device 102 is toward the 3GPP network, (assuming that the user device is sending data using the non-3GPP network) the user device 102 may initiate additional transmission using the 3GPP network to share the traffic load of the non-3GPP network with the 3GPP network. For example, the user device 102 may send 40% of traffic using the non-3GPPt network and 60% of traffic using the 3GPP network.

The network functions described herein may be generally referred to as a generic combination function that may run on one or more servers, one or more instances, one or more sets of instructions, and so on. Such instances may be containerized, replicated, scaled, and distributed by network 210, 240 to meet the growing demands of respective networks. Any of the steps or functions described in one or more of the methods, architectures, or call flows described herein may be used in conjunction with any of the other methods, architectures, or call flows described herein. Any of the components (e.g., network functions, user equipment, servers, and/or the like) may perform any of the steps from any of the methods or call flows described herein even though not specifically described and may be performed in combination with any of the other components. It should be appreciated that the techniques described herein relate to various protocols and technology and may at least apply to 3G, 4G, and 5G technologies.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving by a user device, a network policy associated with a geolocation of the user device;
determining, based on the network policy, traffic flow of a first network and traffic flow of a second network;
determining a vector parameter indicative of a directional movement of the user device toward the second network; and
sending, by the user device, based on the vector parameter and based on the traffic flow of the second network, a request to connect to the second network.

2. The method of claim 1, wherein the first network is a 3GPP network and the second network is a non-3GPP network.

3. The method of claim 1, wherein the vector parameter comprises a speed associated with the user device and a direction of the user device.

4. The method of claim 1, wherein the network policy comprises a steering mode and wherein the steering mode comprises an active-standby mode, a smallest delay mode, a load-balancing mode, a priority-based mode, and a redundant mode.

5. The method of claim 4, wherein the traffic flow of the first network and the traffic flow of the second network are indicated in the steering mode of the network policy.

6. The method of claim 1, wherein the network policy further comprises an identifier indicative of boundary associated with the user device, and wherein the boundary is an area associated with the device.

7. The method of claim 6, wherein the vector parameter indicative of the directional movement of the user device toward the second network is further determined based on the geolocation of the user device and the identifier indicative of the boundary associate with the user device.

8. A method comprising:
sending, by a user device, a first packet via a first network;
receiving, based on a geolocation of the user device, a network policy;
determining, based on the network policy, traffic flow of the first network and traffic flow of a second network;
determining a vector parameter indicative of a directional movement of the user device toward the second network; and
sending, by the user device, based on the vector parameter and based on the traffic flow of the second network, a second packet via the second network.

9. The method of claim 8, wherein the vector parameter comprises a speed associated with the user device and a direction of the user device.

10. The method of claim 8, wherein the network policy comprises a steering mode, and wherein the steering mode comprises an active-standby mode, a smallest delay mode, a load-balancing mode, a priority-based mode, and a redundant mode.

11. The method of claim 10, wherein the traffic flow of the first network and the traffic flow of the second network are indicated in the steering mode of the network policy.

12. The method of claim 8, wherein the network policy further comprises an identifier indicative of boundary associated with the user device, and wherein the boundary is an area associated with the device.

13. The method of claim 12, wherein the vector parameter indicative of the directional movement of the user device toward the second network is further determined based on the geolocation of the user device and the identifier indicative of the boundary associate with the user device.

14. The method of claim 8, wherein the first packet and the second packet are part of the same data stream.

15. A method comprising:
receiving, by a user device, based on a geolocation of the user device, a network policy comprising a steering mode indicative of access to at least one of a first network or a second network;
determining a vector parameter indicative of directional movement of the user device; and
sending, based on the steering mode and the vector parameter, data using at least one of the first network or the second network.

16. The method of claim 15, wherein the first network is a 3GPP network and the second network is a non-3GPP network.

17. The method of claim 15, wherein the vector parameter comprises a speed associated with the user device and a direction of the user device.

18. The method of claim 15, wherein the steering mode comprises an active-standby mode, a smallest delay mode, a load-balancing mode, a priority-based mode, and a redundant mode.

19. The method of claim 15, wherein the network policy further comprises an identifier indicative of boundary associated with the user device, and wherein the boundary is an area associated with the device.

20. The method of claim 19, wherein the vector parameter indicative of the directional movement of the user device toward the second network is further determined based on the geolocation of the user device and the identifier indicative of the boundary associate with the user device.
